(19) United States
(12) Patent Application Publication
(10) Pub. No.: US 2002/0096196 A1
(43) Pub. Date: Jul. 25, 2002

(54) Substrate processing apparatus and substrate processing method

(76) Inventors: Takayuki Toshima, Nirasaki-Shi (JP); Takehiko Orii, Nirasaki-Shi (JP)

Correspondence Address: SMITH, GAMBRELL & RUSSELL, LLP, 1850 M STREET, N.W., SUITE 800, WASHINGTON, DC, 20036, US

(21) Appl. No.: 10/052,534

(22) Filed: Jan. 23, 2002

(30) Foreign Application Priority Data
Jan. 23, 2001 (JP) 2001-015027
May 21, 2001 (JP) 2001-150283

(51) Int. Cl. B08B 3/00

(52) U.S. Cl. 134/21; 134/902; 134/26; 134/95.2; 134/95.3; 134/172; 134/36; 134/105; 134/153

(57) ABSTRACT

A substrate processing apparatus 8 for feeding a processing liquid and processing a substrate W with the processing liquid comprises holding member 22 for holding the substrate W, and a lower side member 42 which is moved relatively with respect to the back surface of the substrate W held by the holding member 22 between a processing position A near the substrate undersurface and a retreat position B remote from the substrate undersurface. The processing liquid is fed between a gap between the lower side member 42 moved to the processing position A and the back surface of the substrate held by the holding member 22, and the substrate undersurface is processed. A cleaning processing unit 221a as one embodiment of the liquid processing apparatus comprises a spin chuck 22 for holding a wafer W substantially horizontally, a stage 224 substantially horizontally below the wafer W held by the spin chuck 223, and a cleaning liquid discharge openings 241 for feeding a required cleaning liquid into a gap between the wafer W held by the spin chuck 223 and the stage 224. The stage 224 has the surface coated with a hydrophobic polymer so that the surface has wetting which allows a contact angle of the cleaning liquid to be above 50E. A layer of the cleaning liquid is formed in the gap between the wafer W held by the spin chuck 223 and the stage 224 to subject the wafer W to the liquid processing.

### CROSS REFERENCE TO RELATED APPLICATIONS

The subject application is related to subject matter disclosed in Japanese Patent Application No. 2001 -15027 filed on Jan. 23, 2001 and Japanese Patent Application No. 2001 -150283 filed on May 21, 2001 in Japan to which the subject application claims priority under Paris Convention and which are incorporated herein by reference.

### BACKGROUND OF THE INVENTION

1. Field of the Invention

The present invention relates to a substrate processing apparatus for cleaning substrates, such as semiconductor wafers, LCD glass substrates, etc., and a substrate cleaning method. The present invention relates also to a liquid processing apparatus (processing apparatus) for making liquid processing, as of cleaning, etc., on semiconductor wafers, LCD substrates, etc., and a liquid processing method (processing method).

2. Related Background Art

Semiconductor device fabrication processes, for example, use cleaning systems for cleaning semiconductor wafers (hereinafter called “wafers”) with chemical liquids, pure water, etc. to remove contaminations, as of particles, organic contaminants and metal impurities staying on the wafers. Among such cleaning systems is known the single wafer cleaning system comprising a spin-substrate cleaning apparatus which cleans a wafer on rotation.

Generally, such cleaning system comprises carriage means for carrying wafers, and the carriage means loads and unloads a wafer in and out of a substrate cleaning apparatus. The cleaning apparatus comprises a spin chuck for holding and rotating a wafer, and when a wafer is loaded and unloaded in and out of the cleaning apparatus, the wafer is transferred between the arm of the carrier means and the spin chuck. In the substrate cleaning apparatus, generally a wafer is held by the spin chuck with the surface of the wafer for a semiconductor device to be fabricated on (the wafer front surface) faced upward. The wafer is held, e.g., by having the peripheral edge of the wafer mechanically held or by having the wafer back surface sucked. While the wafer thus held by the spin chuck is being rotated, a prescribed cleaning liquid is fed onto the wafer front surface to be cleaned. It is possible that a wafer is cleaned with a brush or the like which is in contact with the wafer while a prescribed cleaning liquid is being fed to the wafer front surface.

In such cleaning apparatus, a cleaning liquid is continuously fed to a wafer on rotation, and accordingly a liquid consumption is large. The cleaning liquid cannot be fed to the back surface of the wafer (the surface of the wafer where a semiconductor device is not to be fabricated, i.e., the wafer back surface) held by the spin chuck, and accordingly only one surface of the wafer can be cleaned.

Then, the specification of Japanese Patent Laid-Open Publication No. 1996 -78368 discloses a wafer cleaning apparatus in which a wafer is held by a plurality of support pins provided on a spin chuck, and a cleaning liquid is fed to the wafer front surface and also to a gap(space) between the wafer and the spin chuck so as to clean the wafer, whereby a consumption of the cleaning liquid can be saved, and both surfaces of the wafer can be concurrently cleaned. The wafer cleaning apparatus further comprises a lid which is movable relatively with respect to the wafer front surface, and the cleaning liquid is fed also to a gap between the wafer held at a prescribe distance and the lid so as to clean the wafer front surface.

In the substrate cleaning apparatus of Japanese Patent Laid-Open Publication No. 1996 -78368, however, the gap must be small so that the cleaning liquid can be fed throughout the gap between the wafer back surface and the spin chuck. A height of the support pins are made accordingly low, with a resultant risk that when the arm of the carriage means transfers a wafer to and from the support pins, the arm may collide with the spin chuck. The substrate cleaning apparatus further comprises a member moving over the front side (hereinafter called “a upper side member”) which is movable relatively with respect to the wafer front surface. The cleaning liquid on the wafer front surface is sandwiched between the upper side member and the wafer front surface so as to perform the cleaning. However, as described above, relatively higher cleaning ability is required on the wafer front surface, on which a semiconductor device is to be fabricated. In a case that the upper side member is directly contacted to the cleaning liquid, when particles, etc. stay on the upper side member, there is a risk that the particles may contaminate the cleaning liquid.

On the other hand, in the substrate cleaning apparatus, in a case that the support pins are made high for the prevention of the collision of the spin chuck, a cleaning liquid puddle which fills the gap between the wafer and the spin chuck cannot be formed. And also, in the case that the support pins are made high, a prescribed amount of the cleaning liquid must be continuously fed with the wafer being rotated as required, which causes a problem that a consumption of the cleaning liquid is increased.

### SUMMARY OF THE INVENTION

The present invention was made in view of the above-described circumstances. A first object of the present invention is to provide a substrate processing apparatus and a substrate processing method which can smoothly load and unload a substrate and can improve cleaning efficiency.

A second object of the present invention is to provide a liquid processing apparatus which can smoothly and safely transfer a substrate to and from holding means (a holding member) for holding a substrate.

A third object of the present invention is to provide a liquid processing apparatus and a liquid processing method which can process the front and the back surfaces of a substrate(hereinafter called “an upper surface of the substrate” and “an undersurface of the substrate”) with processing liquids concurrently and homogeneously while decreasing consumptions of the processing liquids.

A fourth object of the present invention is to provide a liquid processing apparatus and a liquid processing method which can improve cleaning quality.

To solve the above-described problems, the present invention provides a substrate processing apparatus for processing a substrate with a processing liquid fed to the substrate, comprising a holding member for holding the substrate; and a lower side member which is movable relatively with respect to an undersurface of the substrate held by the holding member between a processing position near the undersurface of the substrate and a retreat position remote from the undersurface of the substrate, the processing liquid being fed to a space between an upper surface of the lower side member moved to the processing position and the undersurface of the substrate held by the holding member to process the undersurface of the substrate.

In the present invention, a substrate is exemplified by a semiconductor wafer, a glass substrate for LCD or others and may be a CD substrate, a print substrate, a ceramic substrate or others. The upper surface of the substrate is specular so that a semiconductor device, etc. can be fabricated on, and the undersurface of the substrate is relatively rough. The processing liquid includes cleaning liquids, e.g., various chemical liquids, pure water, etc. The substrate processing apparatus according to the present invention is exemplified by a substrate cleaning apparatus for feeding a cleaning liquid to, e.g., a wafer or others, and processing the wafer or others.

In the substrate processing apparatus according to the present invention, a carriage means for carrying, e.g., a substrate, loads the substrate into the substrate processing apparatus and transfers the substrate to the holding member with, e.g., the front surface of the substrate faced upward (with the back surface of the substrate faced downward). At this time, the lower side member has been relatively moved to the retreat position. The carriage means can smoothly load the wafer without contacting the lower side member. Then, the lower side member is relatively moved to the processing position. The processing liquid is fed between the lower side member and the undersurface of the substrate(the substrate undersurface), and the substrate undersurface is processed. On the other hand, when the processed substrate is unloaded out of the substrate processing apparatus, the lower side member is relatively moved to the retreat position. The carriage means can unload the substrate from the holding member without contacting the lower side member. Thus, the unloading can be smoothly performed.

In the substrate processing apparatus, it is preferable that the holding member is rotatable. The holding member, for example, rotates the substrate held thereon. The rotation of the substrate generates flows in the processing liquid fed between the lower side member and the substrate undersurface, and the processing liquid flows prevents the stagnation of the processing liquid and improves the processing efficiency. When the processing liquid is puddled, e.g., between the lower side member and the substrate undersurface, the holding member rotates the substrate at a relatively low rotation velocity (e.g., below 30 -50 rpm) which does not collapse the puddle or intermittently rotates the substrate, whereby after the processing liquid has been fed uniformly between the lower side member and the substrate undersurface, it is not necessary to feed fresh processing liquid; unless a configuration of the puddle collapses, the entire substrate undersurface can be processed with the processing liquid which has been fed between the lower side member and the substrate undersurface. On the other hand, when the puddle collapses, fresh processing liquid is fed to suitably repair the puddle. Thus a consumption of the processing liquid can be made small. It is also possible that the processing liquid is caused by the rotation of the substrate to flow out of the gap(space) between the lower side member and the substrate undersurface while fresh processing liquid is fed into the gap, whereby the processing liquid between the lower side member and the substrate undersurface can be incessantly replaced with fresh processing liquid to thereby make the processing suitable. In this case, preferably the fresh liquid is quietly fed to save the processing liquid. It is also possible that after the processing liquid has been fed onto the lower side member and puddled thereon, the lower side member is relatively moved to the processing position, and the processing liquid is made contiguous to the entire undersurface of the substrate to process the substrate undersurface.

In the substrate processing apparatus, the above is the same with the case where the lower side member is rotatable.

In the substrate processing apparatus, the lower side member may be movable to a processing liquid scattering position, in addition to the processing position and the retreat position, where the step of rotating the substrate to scatter away the processing liquid is performed.

In the substrate processing apparatus, it is preferable that the lower side member includes a lower side temperature adjusting mechanism for adjusting a temperature of the processing liquid. The lower side temperature adjusting mechanism adjust the processing liquid to a prescribed temperature to advance, e.g., the reaction. The lower side temperature adjusting mechanism may include a temperature adjusting path which is provided inside the lower side member and through which a fluid having a temperature adjusted flows.

In order to clean both substrate surfaces, it is possible that the processing liquid is fed to the upper surface of the substrate held by the holding member. The substrate processing apparatus may comprise a upper side member which can be moved relatively with respect to the upper surface of the substrate held by the holding member to be near the substrate upper surface. The substrate processing apparatus may comprise a liquid temperature adjusting mechanism for adjusting a temperature of the processing liquid to be fed to the substrate upper surface. The upper side member may include a upper side temperature adjusting mechanism for adjusting the processing liquid to be fed to the substrate upper surface to a prescribed temperature.

The present invention also provides a substrate processing apparatus for processing a substrate with a processing liquid fed to the substrate, comprising a holding member for holding the substrate in a substantially horizontal position; a lower side member disposed in a substantially horizontal position below the substrate held by the holding member, an upper surface of the lower side member coming into contact with the processing liquid at a contact angle of not less than 50° ; and a first processing liquid feed path for feeding the processing liquid into a space between an undersurface of the substrate held by the holding member and the upper surface of the lower side member, a layer of the processing liquid being formed in the space between the undersurface of the substrate held by the support member and the upper surface of the lower side member.

According to the substrate processing apparatus of the present invention, a puddle of a processing liquid can be firmly formed since the lower side member disposed below the substrate held by the holding member has a hydrophobic property to the processing liquid in order to increase the contact angle when contacting the processing liquid. Thus the distance between the substrate and the lower member is more freely arranged, and therefore the processing liquid layer of a specific thickness can be firmly formed to make liquid processing evenly contiguous to the undersurface of the substrate. In addition, the substrate can be entirely covered including its edge surface with the processing liquid, and accordingly even the edge portion of the substrate, which is hard to liquid-process, can be liquid-processed.

Besides, there is no need to continuously feed the processing liquid because the layer of sufficient amount of the processing liquid can stay still, and consequently the consumption of the processing liquid can be reduced. Also, a collision of the carrying arm with the lower side member can be prevented, which transfers the substrate to and from the lower member, since the distance between the substrate and the lower member can be larger.

The present invention provides a substrate processing method for processing a substrate held by a holding member with a processing liquid fed to the substrate, comprising a first step of holding the substrate by the holding member; a second step of moving the lower side member relatively with respect to the undersurface of the substrate held by the holding member from a retreat position which is remote from the undersurface of the substrate to a processing position which is near the undersurface of the substrate, and making the processing liquid contiguous to the undersurface of the substrate held by the holding member to process the undersurface of the substrate; a third step of drying the substrate; and a fourth step of unloading the substrate from the holding member.

In the substrate processing method, when a substrate is transferred to the holding member to hold the substrate by the holding member, and when the substrate is transferred from the holding member, the lower side member is relatively moved to the retreat position, whereby the substrate can be smoothly transferred to and from the holding member.

### BRIEF DESCRIPTION OF THE DRAWINGS

FIG. 1 is a perspective view of a cleaning system including substrate processing apparatuses according to one embodiment of the present invention.

FIG. 2 is a plan view of the substrate processing apparatus according to the present embodiment.

FIG. 3 is a vertical sectional view of the substrate processing apparatus according to the present embodiment.

FIG. 4 is an enlarged vertical sectional view of the spin chuck.

FIG. 5 is a perspective view of the upper side feed nozzle.

FIG. 6 is a vertical sectional view of the upper side feed nozzle.

FIG. 7 is a perspective view showing the feed of a cleaning liquid from the upper side feed nozzle to a wafer.

FIG. 8 is a view explaining the step of loading a wafer into the substrate cleaning apparatus.

FIG. 9 is a view explaining the step of transferring the wafer to the spin chuck.

FIG. 10 is a view explaining the step of feeding the chemical liquid between the lower side member and the wafer back surface to puddle the processing liquid on the wafer back surface.

FIG. 11 is a view explaining the step of puddle cleaning both wafer surfaces.

FIG. 12 is a view explaining the step of rinsing both wafer surfaces.

FIG. 13 is a view explaining he step of drying both wafer surfaces.

FIG. 14 is a view explaining the step of transferring a wafer from the spin chuck.

FIG. 15 is a view explaining the step of unloading the wafer out of the substrate cleaning apparatus.

FIG. 16 is a view explaining the step of puddling the chemical liquid o the lower side member before the lower side member is moved to the processing position.

FIG. 17 is a perspective view of a modification of the upper side feed nozzle.

FIG. 18 is a longitudinal sectional view of the upper side feed nozzle shown in FIG. 17.

FIG. 19 is a longitudinal sectional view of a modification of the upper side member.

FIG. 20 is a longitudinal sectional view of the substrate cleaning apparatus according to another embodiment of the present invention.

FIG. 21 is a view explaining a constitution of an example.

FIG. 22 is a table of relationships between mixed content ratios of APM components and removal amounts of a thermal oxide film in SCI puddle cleaning of the thermal oxide film in the present example.

FIG. 23 is a graph of the relationships shown in FIG. 22.

FIG. 24 is a view explaining the constitution of the present example with a lid disposed above a wafer.

FIG. 25 is a table of relationships between defined between the lid and the wafer and removal amounts of a thermal oxide film in the SCI puddle cleaning of the thermal oxide film with the lid disposed above the wafer in the present example.

FIG. 26 is a graph of the relationships shown in FIG. 25.

FIG. 27 is a table relationships between mixed content ratios of the AMP components and removal amounts of the thermal oxide film in the SCI puddle cleaning with the wafer adjusted in temperature and with the lid disposed above the wafer in the present example.

FIG. 28 is a graph of the relationships shown in FIG. 27.

FIG. 29 is a plan view of a cleaning system including substrate processing apparatuses according to one embodiment of the present invention showing its general construction.

FIG. 30 is a side view of the cleaning system shown in FIG. 29 showing its general construction.

FIG. 31 is a sectional view of the cleaning system shown in FIG. 29.

FIG. 32 is a plan view of a cleaning processing apparatus showing its general construction.

FIG. 33 is a sectional view of a cleaning processing apparatus when cleaning wafer W.

FIG. 34 is a sectional view of a cleaning processing apparatus when wafer W is transferred to and from the apparatus.

FIG. 35 is a view explaining drain discharge paths for separately collect cleaning liquid.

FIG. 36A is an explanatory view showing a layer of the processing liquid formed on a disk whose surface is fluorine resin coated.

FIG. 36B is an explanatory view showing a layer of the processing liquid formed on a disk whose surface is not fluorine resin coated.

FIG. 37A is an explanatory view showing liquid processing for a wafer using processing liquid in a cleaning processing apparatus according to one embodiment.

FIG. 37B is an explanatory view showing liquid processing for a wafer using processing liquid in a cleaning processing apparatus according to one embodiment.

FIG. 38A is an explanatory view showing liquid processing for a wafer using processing liquid in a cleaning processing apparatus according to another embodiment.

FIG. 38B is an explanatory view showing liquid processing for a wafer using processing liquid in a cleaning processing apparatus according to another embodiment.

FIG. 39 is an explanatory view showing cleaning processing steps carried out in a cleaning system.

FIG. 40 is a plan view of a cleaning processing apparatus according to another embodiment.

FIG. 41 is a sectional view of the cleaning processing apparatus shown in FIG. 40.

FIG. 42A is a perspective view of a nozzle which can be used in the cleaning processing apparatus of the present invention.

FIG. 42B is a perspective view of another nozzle which can be used in the cleaning processing apparatus of the present invention.

FIG. 43 is an explanatory view of a wafer according to one embodiment when a cover member and a stage is retreated after cleaning.

### DESCRIPTION OF PREFERRED EMBODIMENTS

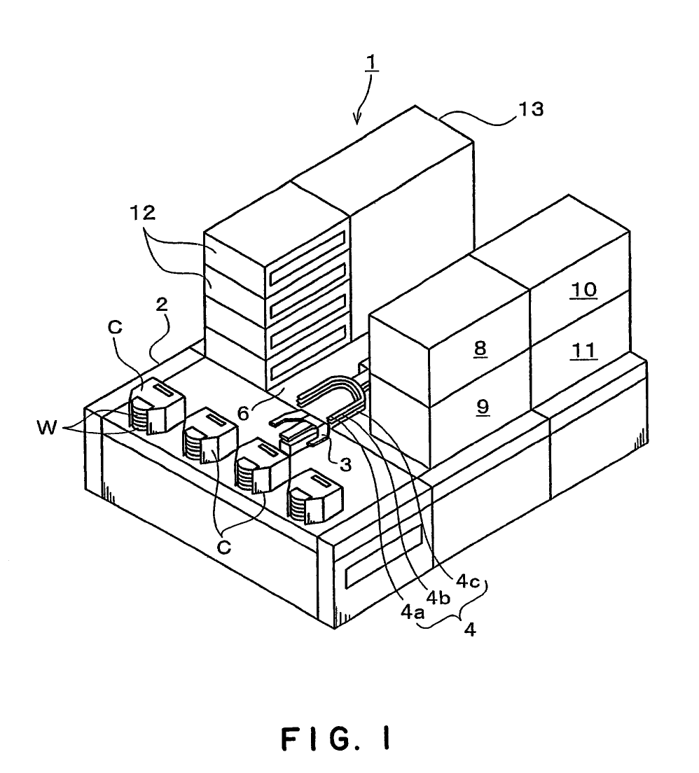

Preferred embodiments of the substrate processing apparatus according to the present invention will be explained below by means of a substrate cleaning apparatus for cleaning both surfaces of a wafer as an example of the substrate. FIG. 1 is a perspective view of a cleaning system 1 incorporating the substrate cleaning apparatuses 8, 9, 10, 11 according to the present embodiment. The cleaning system 1 loads wafers W in the unit of a carrier C, cleans and dries the wafers one by one, and unloads the wafers W in the carrier unit.

The cleaning system 1 includes amount 2 which can accommodate four carriers containing wafers W. A loading/unloading arm 3 for loading the wafers W to be cleaned onto the mount 2 from the carrier C one by one and unloading the cleaned wafers W into the carrier C is disposed at the center of the cleaning system 1. A transfer arm 4 which transfers the wafers W to and from the loading/unloading arm 4 stands by behind the loading/unloading arm 3. The transfer arm 4 is movable along a carriage path 6 provided at the center of the cleaning system 1. The transfer arm 4 has three arms 4a, 4b, 4c and transfers with the arms 4a, 4b, 4c the wafers C to and from various processing apparatuses arranged on both sides of the carriage path 6. The various processing apparatuses are exemplified by the substrate cleaning apparatuses 8, 9 according to the present embodiment arranged one on the other in two stages and the substrate cleaning apparatuses 10, 11 arranged one on the other in two stages, which are disposed on one side of the carriage path 6. On the other side of the carriage path 6, four heating apparatuses 12 for heating and drying the wafers W are arranged one on another in four stages. Adjacent to the heating apparatuses 12 there is arranged a control area 13 including a printed circuit board, etc. of an electric control system for the cleaning system 1. The wafers W have the upper surfaces made specular so that a semiconductor device, for example, can be fabricated thereon and the back surface made rough.

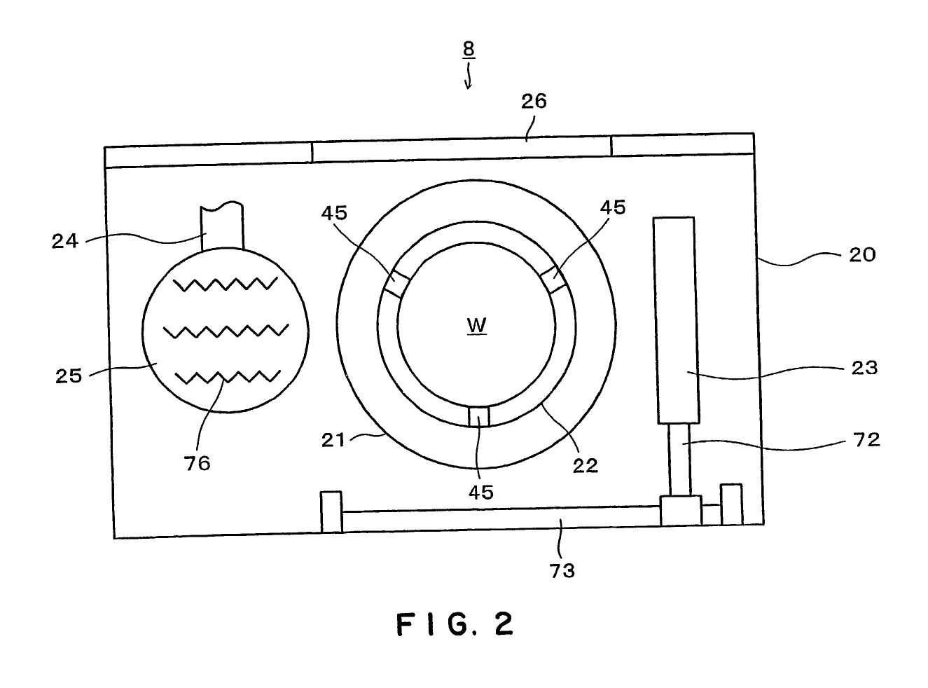

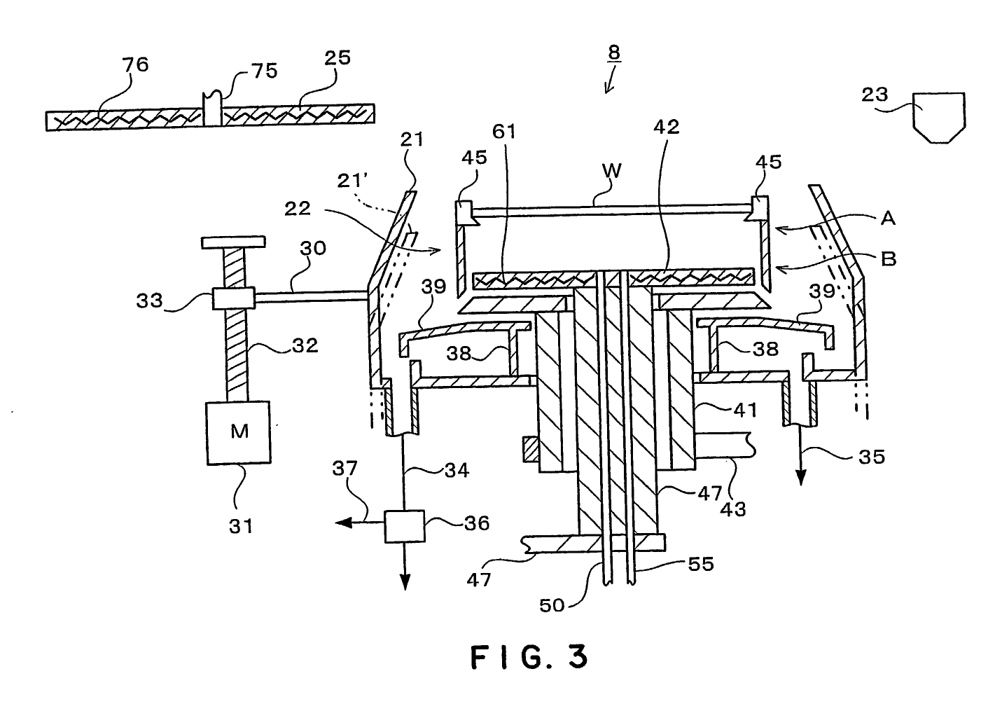

The substrate cleaning apparatuses 8-11 have the same constitution so that cleaning liquids are puddled on the upper surface and undersurface of the wafers W to clean the wafers W by the so-called puddle cleaning. The substrate cleaning apparatuses 8-11 will be explained by means of the substrate cleaning apparatus 8. FIG. 2 is a plan view of the substrate cleaning apparatus 8. FIG. 3 is a vertical sectional view of the substrate cleaning apparatus 8. As shown in FIGS. 2 and 3, a cup 21 for accommodating a wafer W, and a spin chuck 22 for rotatably holding the wafer W with, e.g., the wafer upper surface faced upward are disposed in a casing 20 of the substrate cleaning apparatus 8. On one side of the interior of the casing 20, there are disposed a upper side feed nozzle 23 as means for supplying cleaning liquids to the upper surface of the wafer W (wafer upper surface) held by the spin chuck(holding member) 22. On the other side of the interior of the casing 20, there is disposed a upper side member 25 which is moved by a driving mechanism, such as a motor or others, relatively with respect to the wafer upper surface held by the spin chuck 32. The casing 20 has an openable/closable shutter 26 provided on the front side thereof (side opposed to the carriage path 6 of the cleaning system shown in FIG. 1). The shutter 26 is opened when a wafer is loaded into the substrate cleaning apparatus 8 by the transfer arm 4.

A bracket 30 is secured to a side of the cup 21 and is connected to a nut screw-engaged with a pole screw 32 which is rotated by a motor 31. Thus, the cup 21 can be moved up and down by the clock-wise and the counter-clock-wise rotation of the motor 31 to a position indicated by the two-dot chain line 21′ in FIG. 3 where the spin chuck 22 is projected above the cup 21 to transfer a wafer W, and lifts the cup 21 to the position indicated by the solid line 21 in FIG. 3 where the cup 21 surrounds the spin chuck 22 and the wafer W to prevent the cleaning liquids, etc. fed to both surfaces of the wafer W from scattering.

A liquid drain pipe 34 for discharging liquid drops in the cup 21 and a gas discharge pipe 35 for discharging an atmosphere in the cup 21 are connected to the bottom of the cup 21. The liquid drain pipe 34 has a gas/liquid separating box 36, and the gas/liquid separating box 36 removes bubbles, etc. from the liquid drops drained by the gas/liquid separating box 36. The removed bubbles are discharged outside through an exhaust pipe 37 connected to the gas/liquid separating box 36. An annular partition wall 38 is erected on the bottom of the cup 21, and a rectifying plate 39 declined outward is disposed on the upper end of the partition wall 38.

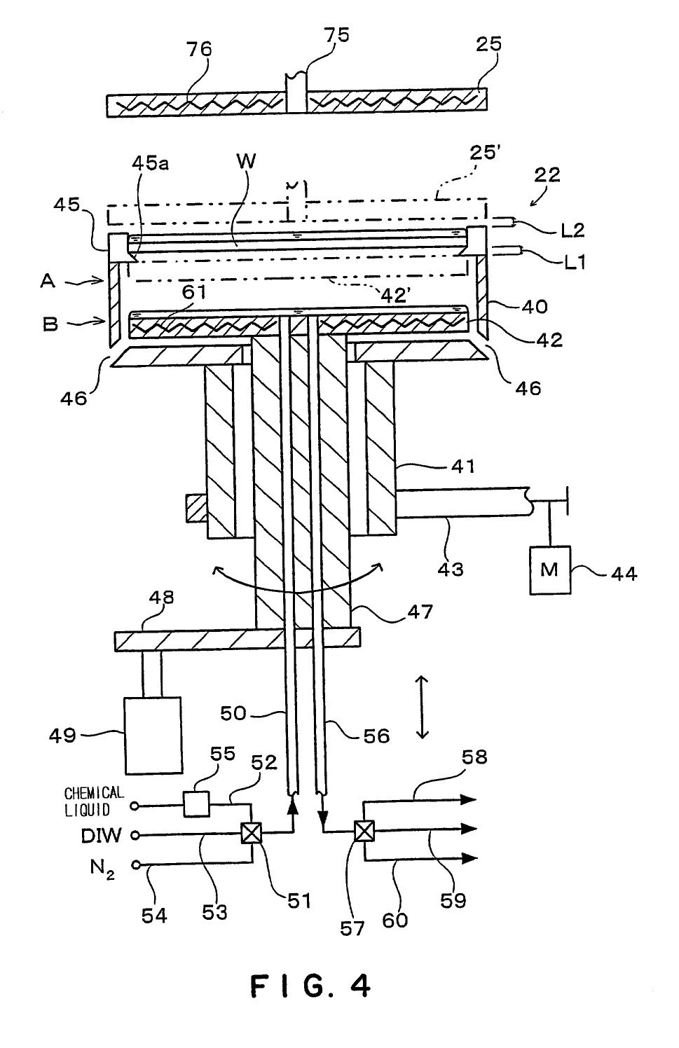

As shown in FIG. 4, the spin chuck 22 comprises a chuck body 40 for holding a wafer W, and a rotary cylinder 41 connected to the bottom of the chuck body 40. In the chuck body 40, a lower side member 42 which is moved relatively with respect to the undersurface of a wafer W (wafer undersurface) held by the spin chuck 22 is disposed. A belt 43 is wound around the outer circumferential surface of the rotary cylinder 41, and is circumferentially driven by a motor 44 to rotate the whole spin chuck 22.

Holding members 45 for holding a peripheral edge of a wafer W at a plurality of positions are mounted on the top of the chuck body 40. The holding members 45 have declined surfaces 45a gradually lowered from the peripheral edge of the chuck body 40 to the center thereof. The holding members 45 hold a wafer W at the declined surfaces 45a. Weights may be disposed in the respective holding members 45, so that the upper parts of the respective holding members 45 are displaced in ward by a centrifugal force produced when the spin chuck 22 is rotated. A discharge opening 46 is provided circumferentially in the bottom of the chuck body 40 at a suitable position. Liquid drops and an atmosphere in the chuck body 40 are discharged through the discharge opening 46.

The lower side member 42 is connected to a shaft 47 put through the chuck body 40 and the rotary cylinder 41. The shaft 47 is secured to the upper surface of a horizontal plate 48. The horizontal plate 48 is vertically moved up and down by a lift mechanism 49 in the form of a cylinder or others. Accordingly, the lower side member 42 can be freely moved in the chuck body 40 up to a position processing position A) indicated by the two-dot line 42′ in FIG. 4, where the cleaning processing is being made on the undersurface of a wafer W held by the spin chuck 22 and down to a position (retreat position B) indicated by the solid line 42 in FIG. 4, where the lower side member 42 stands by apart from the undersurface of the wafer W held by the spin chuck 22. The lower side member 42 can be moved to a position (processing liquid scattering position) not shown, where the wafer W is rotated to scatter away processing liquids staying on the surfaces. The lower side member 42 is caused to stand by in the retreat position B when, as described above, the cup 2 is lowered to the position indicated by the two-dot chain line 21′ to transfer a wafer W to and from the spin chuck 22. Thus, a gap sufficient to transfer the wafer W to and from the spin chuck 22 can be formed between the lower side member 42 and a position (height) of the wafer W held on the spin chuck 22. With the lower side member 42 fixed at a prescribed height, a lift mechanism not show is connected to the rotary cylinder 41 to move vertically up and down the whole spin chuck 22 to thereby move the lower side member 42 between the processing position A and the retreat position B.

A lower side feed path(first processing liquid feed path) 50 for feeding cleaning liquids, e.g., a chemical liquid, pure water, etc., and a drying gas to the upper surface of the lower side member 42 is provided through the shaft 47. The lower side feed path 50 is communicated through a three-way valve 51 with a chemical liquid feed path 52, a pure water feed path 53 and a gas feed path 54. The three-way valve 51 is changed over to switch a fluid to be fed to the upper surface of the lower side member. A temperature adjuster 55, e.g., a heater, for adjusting a temperature of a chemical liquid to be fed to the upper surface of a wafer W is provided in the chemical liquid feed path 52. Although not shown, a temperature adjuster, e.g., a heater, which can adjust temperatures may be provided also in the pure water feed path 53. The lower side feed path 50 functions as means for feeding to the back side, and, for example, when the three-way valve 51 is switched to the chemical liquid feed path 52, a chemical liquid adjusted to a prescribed temperature is fed through the chemical liquid feed path 52. For example, the lower side member 42 is lifted to the processing position A to define, e.g., an about 0.5 -3 mm gap L1 between the lower side member 42 lifted to the processing position A and the undersurface of a wafer W held by the spin chuck 22. The lower side feed path 50 feeds a chemical liquid between the lower side member 42 and the wafer undersurface through the chemical liquid feed path 52. The chemical liquid thus fed to the gap L1 spreads all over the gap L1 to be puddled, forming a liquid film of the chemical liquid, which can uniformly contact the entire wafer undersurface, whereby the cleaning processing is made suitable. Even after the liquid film has been formed, the liquid film of the chemical liquid is held in the gap L1, whereby the collapse of a shape of the liquid film of the chemical liquid can be prevented by a surface tension, and the suitable cleaning processing can be continuously performed. In the same way, pure water is fed through the pure water feed path 53 to feed the pure water onto the lower side member 42. Through the gas feed path 54, room temperature N₂ gas, for example, is fed through the gas feed path 54 (heated hot N₂ gas may be fed), and the wafer undersurface is dried after cleaned.

On the other hand, a lower side discharge path 56 for discharging the cleaning liquids and drying gas fed to the lower side member 42 is provided through the shaft 47. The lower side discharge path 56 is connected to a chemical liquid discharge path 58, a pure water discharge path 59 and a gas discharge path 60 via a three-way valve 57. The liquid films of the chemical liquid and the pure water formed on the lower side member 42 are discharged outside respectively through the chemical liquid discharge path 58 and the pure water discharge path 59. N₂ gas filling the chuck body 40 is discharged outside through the gas discharge path 60. The chemical liquid is exemplified by, e.g., APM (a mixed gas of NH₄OH/H₂O₂/H₂O) containing ammonium as a main component, HPM (a mixed liquid of HCl/H₂O₂/H₂O) containing hydrochloric acid as a main component, DHF (a mixed liquid of HF/H₂O) containing hydrofluoric acid as a main component, etc.

An electric heater 61 is buried in the lower side member 42. The heater 61 functions as a lower side temperature adjusting mechanism, and adjusts, as described above, for example, a chemical liquid fed between the lower side member 42 and the undersurface of a wafer W to a prescribed temperature. The heater 61 may be in the form of a temperature adjusting path through which a liquid having a temperature adjusted by heating flows, and in this case, the temperature adjusting path is provided inside the lower side member 42, and a liquid, preferably water heated by a heater is caused to flow through the temperature adjusting passage to thereby control a temperature of the lower side member.

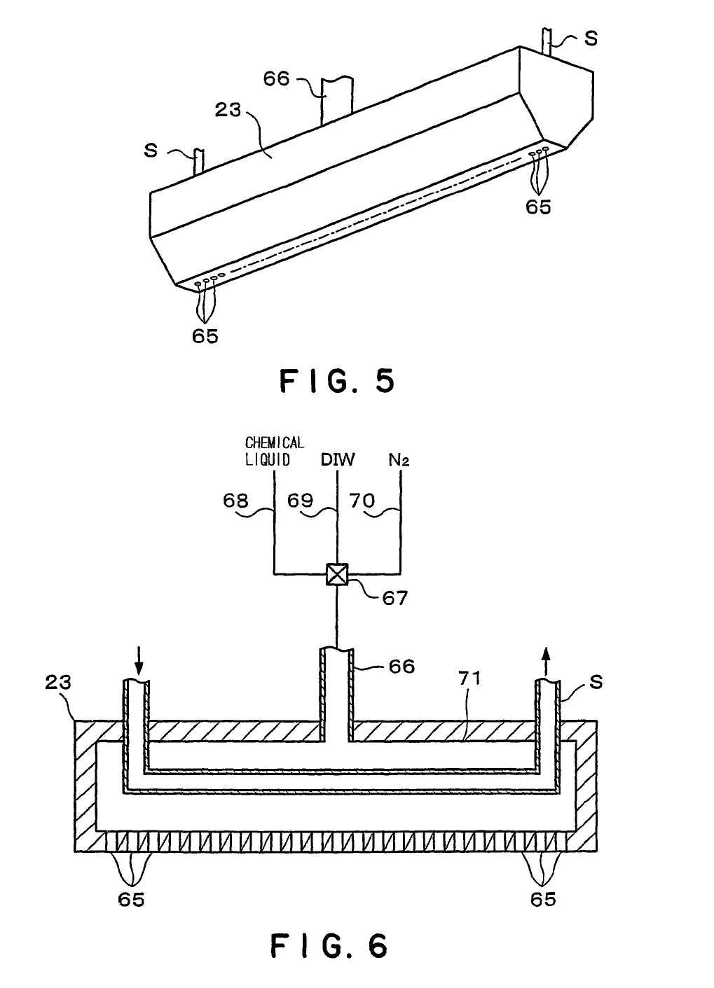

As shown in FIGS. 5 and 6, the upper side feed nozzle 23 has an elongated configuration. A length of the upper side feed nozzle 23 is larger than, e.g., a diameter of a wafer W. A plurality of feed ports (processing liquid discharge openings) 65 are formed in the underside of the upper side feed nozzle 23 longitudinally in one row. A upper side feed path(second processing liquid feed path) 66 for feeding, e.g., a chemical liquid, pure water and N₂ gas is connected to the upper end of the upper side feed nozzle 23. The upper side feed path 66 is connected to a chemical liquid feed path 68, a pure water feed path 69 and a gas feed path 70 through a three-way valve 67. The three-way valve 67 is changed over to switch a fluid to be fed into the upper side feed nozzle 23. A chemical liquid and pure water fed through the chemical liquid feed path 68 and the pure water feed path 59 are temporarily stored in a liquid reservoir 71 disposed in the upper side feed nozzle 23. The liquid reservoir 71 has a space longitudinally extended and is in communication with all the feed holes 65. The cleaning liquids stored in the liquid reservoir 71 is fed to the upper surface of a wafer through the respective feed holes 65. A prescribed amount of a cleaning liquid is ejected at once through a plurality of the plural feed holes 65, whereby the cleaning liquid can be ejected in straight lines longer than a diameter of the wafer.

As shown in FIG. 6, a temperature adjusting path S as a liquid temperature adjusting mechanism for adjusting a temperature of the cleaning liquid in the liquid reservoir 71 is longitudinally disposed in the liquid reservoir 71. The temperature adjusting path S is in the form of a tube or others through which a fluid, e.g., water or others, having the temperature adjusted to a prescribed temperature flows. The temperature adjusting path S can heat-exchange between the inside and the outside of the temperature adjusting path S. The temperature adjusting path S enters the liquid reservoir 71 from an upper side near one end of the upper side feed nozzle, is extended longitudinally through the liquid reservoir 71 and exits the upper side feed nozzle 23 from an upper side near the other end of the upper side feed nozzle 23. Accordingly, water of an adjusted temperature flows inside the temperature adjusting path S to thereby adjust a temperature of a cleaning liquid in the liquid reservoir 71. A chemical liquid adjusted to a prescribed temperature is fed to the upper surface of a wafer W to thereby have high cleaning ability. It is effective to thus arrange the temperature adjusting path S.

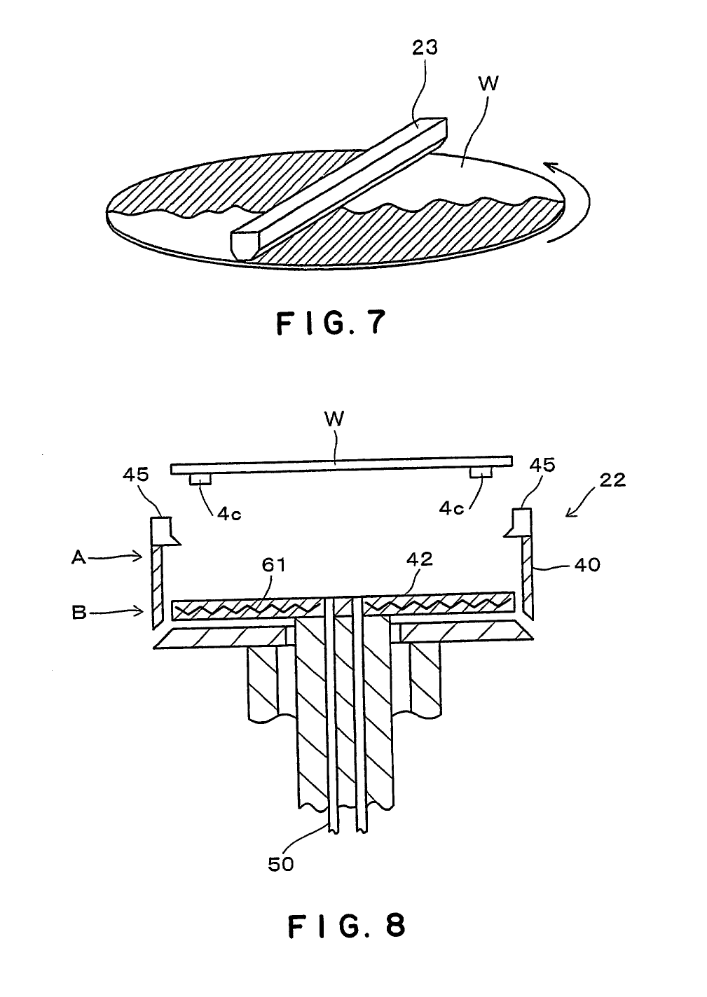

The upper side feed nozzle 23 is supported by a support arm 72 as shown in FIG. 2. The support arm 72 is movable along, e.g., a rail 73 horizontally extended in the longitudinal direction (X direction in FIG. 2) of the substrate cleaning apparatus 8. The support arm 72 is also vertically movable so as to adjust a distance between the upper side feed nozzle 23 and a wafer W. Accordingly, as exemplified in FIG. 7, the support arm 72 moves the upper side feed nozzle 23 in parallelism to a prescribed position above a wafer W. The upper side feed nozzle 23 feed a chemical liquid linearly to a wafer W rotated by 180° at least slowly by the spin chuck 22 to puddle the chemical liquid, whereby a liquid film of the chemical liquid is formed uniformly on the wafer upper surface.

The upper side member 25 can be moved horizontally and vertically by the moving mechanism 24. When a liquid film of a chemical liquid is formed on the upper surface of a wafer W by the upper side feed nozzle 23 as described above, the upper side member 25 is moved horizontally to above the spin chuck 22 and is vertically lowered as indicated by the two-dot chain line 25′, ensuring a distance with respect to the wafer W, down to a position where the upper side member 25 does not contact the liquid film of the chemical liquid formed on the wafer upper surface, i.e., a position near the wafer upper surface. The upper side member thus positioned near the upper surface of a wafer w can be vertically lifted to above the spin chuck 22 and is moved horizontally to a position away from the cup 21 to stand by there. The upper side member 25 can be thus moved toward and away from the upper surface of a wafer W held by the spin chuck 22.

A chemical liquid feed path(second processing liquid feed path) 75 is connected to the upper end of the upper side member 25. Accordingly, the upper side member 25 feeds a chemical liquid to the upper surface of a wafer W.

As in the lower side member 42, a heater 76 which is electrically heated is buried in the upper side member 25. The heater 76 functions as a upper side temperature adjusting mechanism. When the upper side member 25 is moved to a position near the upper surface of a wafer W as indicated by the two-dot chain line in FIG. 4, the heater 76 heats a liquid film of a chemical liquid formed on the upper surface of the wafer W to a prescribed temperature. The upper side member 25 is thus positioned above and over the wafer W, a chemical liquid is prevented from evaporating from its film. A gap L2 is defined between a liquid film of a chemical liquid formed on the upper surface of a wafer W held by the spin chuck 22 and the upper side member 25 moved to the position near the wafer upper surface to thereby keep the upper side member 25 from the direct contact with the liquid film of the chemical liquid. Thus, particles, etc. staying on, e.g., the upper side member 25 are prevented from transferring to a liquid film of the chemical liquid and resultantly lowering cleaning ability of the chemical liquid.

The rest substrate cleaning apparatuses 9, 10, 11 incorporated in the cleaning system 1 have the same constitution as the substrate cleaning apparatus 8 and can concurrently puddle-clean both surfaces of a wafer W with liquid films of a chemical liquid.

Then, in the cleaning system 1, the carriers C each holding, e.g., 25 sheets of wafers W to be cleaned are placed on the mount 2 by a carrier robot. The wafers W are taken out of the carriers C placed on the mount 2 one by one by the loading/unloading arm 3 to be transferred from the loading/unloading arm 3 to the transfer arm 4. The transfer arm 4 loads the wafers W into the respective substrate cleaning apparatuses 8-11 as required, and contaminants, such as particles, etc., staying on the wafers are washed and removed. Thus-cleaned wafers W are unloaded as required out of the respective substrate cleaning apparatuses 8-11 again by the transfer arm 4 and transferred to the loading/unloading arm 3 to be stored back to the carriers C.

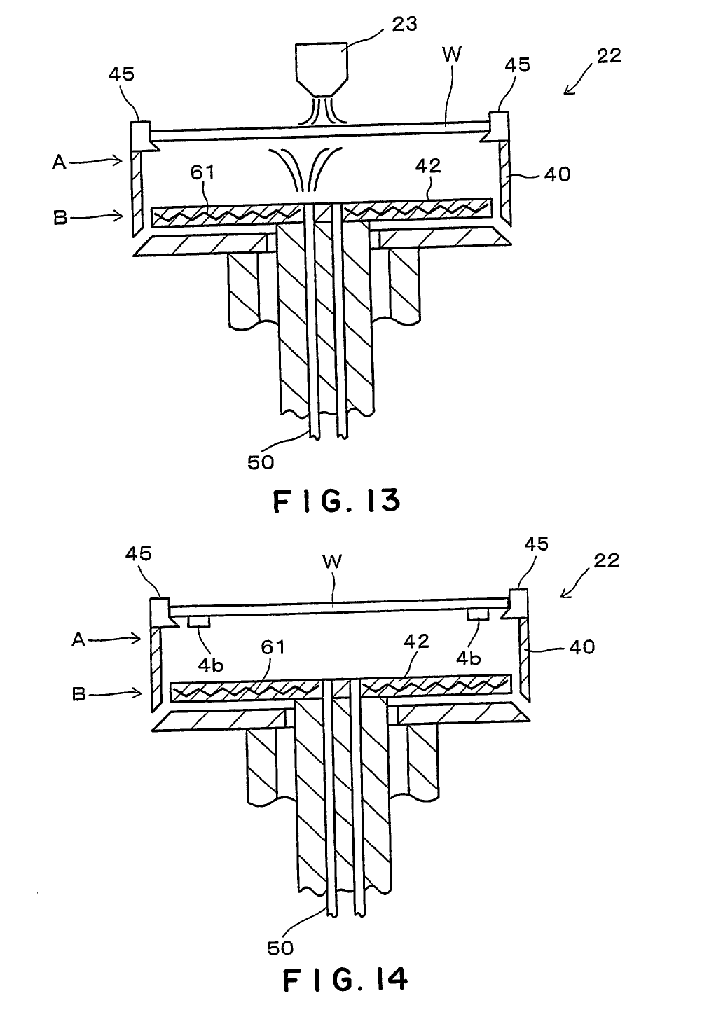

Then, with reference to FIGS. 8-15, the cleaning will be explained by the cleaning carried out by the substrate cleaning apparatus 8. First, the shutter 26 of the substrate cleaning apparatus 8 is opened, and the transfer arm 4 advances the arm 4c holding, e.g., a wafer W into the apparatus. The cup 21 is lowered to project the chuck 40 relatively upward. As shown in FIG. 8, the lower side member 42 has been lowered to the retreat position B in the chuck 40.

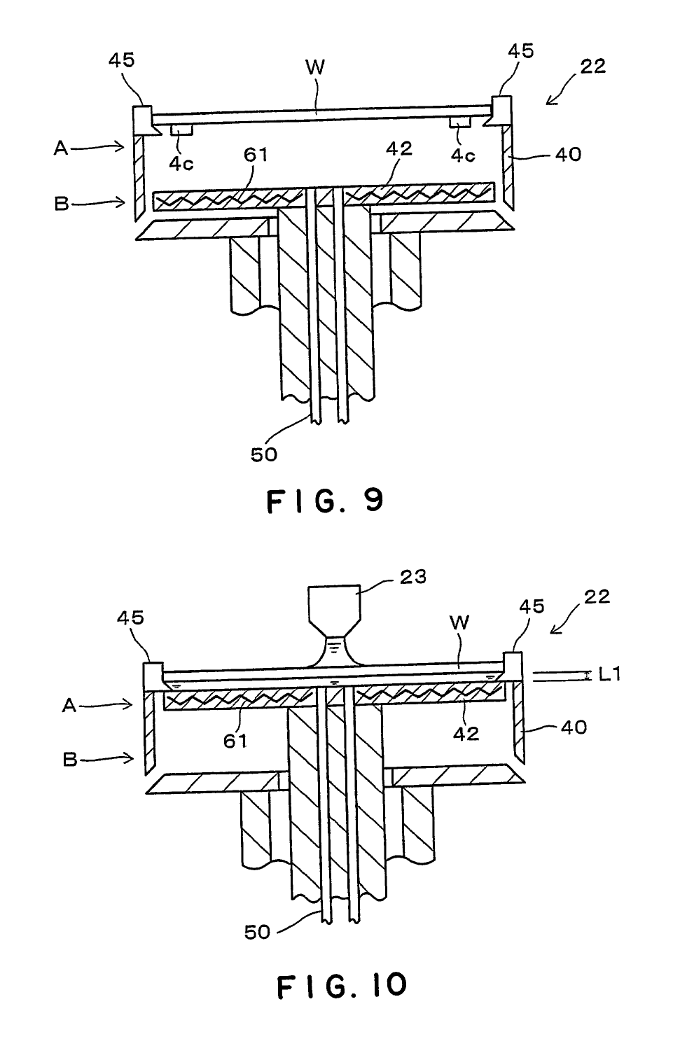

As shown in FIG. 9, the transfer arm 4 lowers the arm 4c to transfer a wafer W to the holding members 45. The spin chuck 22 holds the wafer W with the front surface thereof faced upward, on which a semiconductor device to be fabricated on. At this time, the lower side member 42 is in the retreat position B remote from the position of the wafer W held by the spin chuck 22 enough to make an allowance for the transfer arm 4 to transfer the wafer W to the spin chuck 22.

Then, as shown in FIG. 10, the lower side member 42 is lifted to the processing position A inside the chuck body 40. A gap L1 of, e.g., about 5-3 mm is defined between the upper surface of the lower side member 42 in the processing position A and the undersurface of the wafer W. A chemical liquid is fed to the space between the lower side member 42 and the undersurface of the wafer W through the lower side feed path 50. The three-way valve 51 is changed over to the chemical liquid feed path 52, and the chemical liquid is heated to a prescribed temperature by the temperature adjuster 55. The chemical liquid is, e.g., quietly oozed onto the lower side member 42 through the lower side feed path 50 to feed the chemical liquid to the gap L1. The chemical liquid is spread and puddled all over in the narrow gap L1 to form a liquid layer of the chemical liquid in uniform contact with the entire wafer undersurface. When the liquid layer of the chemical liquid is formed all over the gap L1, the feed of the chemical liquid is stopped to clean the wafer undersurface. The chemical liquid is puddled in the gap L1, forming the liquid layer, whereby a surface tension keeps from a configuration of the liquid layer from collapsing. If the liquid layer of the chemical liquid should collapse, the wafer undersurface will not contact at parts the liquid layer of the chemical liquid, or air bubbles will be mixed in the liquid layer, with a result of defective cleaning. The chemical liquid is thus puddled between the lower side member 42 and the wafer undersurface, whereby the liquid layer of the chemical liquid can retain its configuration so as to prevent the defective cleaning.

At this time, the spin chuck 22 rotates the wafer W at a relatively low velocity (e.g., below 30-50 rpm) which does not collapse the configuration of the liquid layer of the chemical liquid. The rotation of the wafer W generates a liquid flow in the liquid layer of the chemical liquid, and the liquid flow prevents the stagnation of the chemical liquid in the liquid layer, with a result of improved cleaning efficiency. The rotation of the wafer W may be intermittent. For example, the wafer W is rotated for a prescribed period of time or by a prescribed rotation number, then the rotation of the wafer W is stopped for a prescribed period of time to set the wafer W still, and then the wafer W is again rotated. The repetition of such rotation and halt of the wafer W facilitates diffusion of the chemical liquid all over the back surface of the wafer W. Of course the wafer W can be subjected to the cleaning processing, not rotated, kept standstill. After the liquid layer of the chemical liquid has been formed, it is not necessary to feed the chemical liquid; unless the configuration of the liquid layer of the chemical liquid collapses, the entire undersurface of the wafer W can be cleaned with the chemical liquid which has been already fed to the space between the lower side member 42 and the wafer undersurface. However, in a case, for example, that the configuration of the liquid layer of the chemical liquid should collapse, the chemical liquid is added to suitably repair the configuration of the liquid layer of the chemical liquid. Thus, a consumption of the chemical liquid is made small. The chemical liquid in the liquid layer thereof may be incessantly replaced with fresh chemical liquid for suitable chemical liquid processing by falling drops of the chemical liquid of the liquid layer from the peripheral edge of the lower side member 42 while continuously feeding the chemical liquid through the lower side feed path 50. In this case as well, the fresh chemical liquid is fed as quietly as possible to thereby save the chemical liquid.

The heater 61 in the lower side member 42 adjusts the liquid layer of the chemical liquid on the lower side member 42 to a prescribed temperature. The chemical liquid is adjusted in the temperature thus continuously from the feed of the chemical liquid to the formation of the liquid layer, whereby the reaction of the chemical liquid in the liquid layer can be advanced to improve the cleaning efficiency. Particles, organic contaminants and metal impurities staying on, e.g., the undersurface of the wafer W can be removed in a short period of time, and a rate of removing the particles, organic contaminants and metal impurities can be high.

On the other hand, the upper side feed nozzle 23 is moved in parallelism to a prescribed position above the wafer W. The upper side feed nozzle 23 linearly feeds the chemical liquid. That is, the three-way valve 67 is changed over to the chemical liquid feed path 68 to flow the chemical liquid to the upper side feed path 66, and the chemical liquid is adjusted to a prescribed temperature in the liquid reservoir 71 by the temperature adjusting path S and is discharged from the feed ports 65. The wafer W is rotated by at least 180° by the spin chuck 22 to puddle the chemical liquid on the upper surface of the wafer W to form a uniform liquid film.

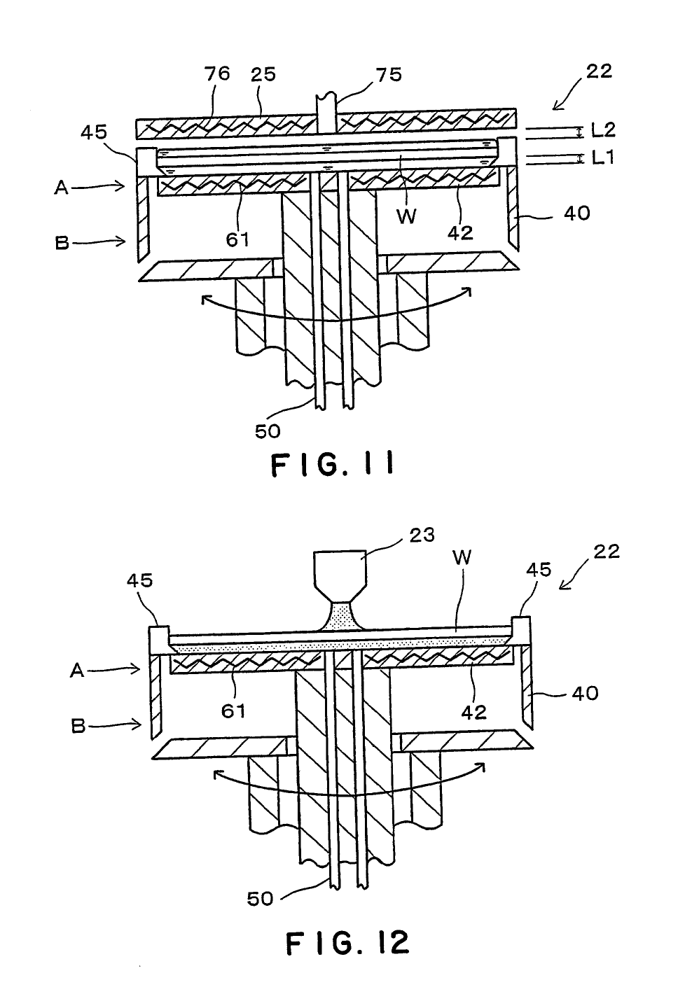

When the liquid film of the chemical liquid is formed on also on the upper surface of the wafer W, as shown in FIG. 11 the upper side member 25 is moved to the position in which the upper side member 25 does not contact the liquid film of the chemical liquid formed on the wafer upper surface and which is near, e.g., the wafer upper surface. A gap L2 is defined between the upper side member 25 moved to the position near the upper surface of, e.g., the wafer and the liquid film of the chemical liquid formed on the wafer upper surface held by the spin chuck 22. Only in a case, however, that a configuration of the liquid film of the chemical liquid on the wafer upper surface should collapse, the upper side member 25 feeds fresh chemical liquid to suitably repair the configuration of the liquid film of the chemical liquid; the chemical liquid processing of the wafer upper surface is performed only with the chemical liquid which has been fed by the upper side feed nozzle 23 so as to reduce the feed of fresh liquid after the liquid film has been formed to thereby make a consumption of the chemical liquid small. It is possible to incessantly replacing the chemical liquid in the liquid film on the wafer upper surface with fresh chemical liquid to make the chemical liquid suitable by continuously feeding the chemical liquid from the upper side member 25 while the wafer W is rotated to fall drops of the chemical liquid from the peripheral edge of the wafer upper surface.

The heater 76 in the upper side member 25 heats the liquid film of the chemical liquid formed on the wafer upper surface to adjust the chemical liquid to a prescribed temperature. The upper side member 25 thus covers the liquid film of the chemical liquid there above, so that the chemical liquid is prevented from evaporating from the liquid film the thereby decrease a liquid amount of the liquid film. The chemical liquid is adjusted in temperature to be retained at a prescribed temperature and accordingly can be kept from lowering cleaning ability. The chemical liquid can be adjusted in temperature continuously from the feed of the chemical liquid to the formation of the liquid film, whereby, on the wafer upper surface as well, the reaction of the chemical liquid in the liquid film can be advanced for high cleaning efficiency. In the gap L2, the upper side member 25 does not contact the liquid film of the chemical liquid formed on the wafer upper surface, and even in a case that particles, etc. stay on the upper side member 25, the liquid film of the chemical liquid can be kept from the contamination with the particles, etc. Especially to the wafer W, which is held by the spin chuck 22 with the front surface of the wafer W faced upward, on which a semiconductor devices, etc. to be fabricated, it is important to thus maintain cleanliness of the liquid film of the chemical liquid.

When the chemical liquid processing is completed on both surfaces of the wafer W, as shown in FIG. 12, the three-way valve 51 is switched to the pure water feed path 53 to flow the pure water to the lower side feed path 50, and the pure water is fed to the back surface of the wafer W. The wafer W is rotated at a higher velocity (e.g., about 500-1000 rpm) larger than that for the chemical liquid processing of the wafer W) while the undersurface of the wafer W is retained at the processing position A or is located at the position where the processing liquid is scattered. The pure water is fed to the wafer W on such high-velocity rotation through the gap L1, whereby the pure water can be dispersed uniformly over the entire undersurface of the wafer W. The lower side member 42 itself can be cleaned. On the other hand, the upper side member 25 is retreated to stand by outside the cup 21. The upper surface feed nozzle 23 is moved in parallelism back to the set position above the wafer W. The upper side feed nozzle 23 feeds the pure water linearly to the wafer upper surface. That is, the three-way valve 67 is changed over to the pure water feed path 69 to flow the pure water to the upper side feed path 66. The pure water is fed to the wafer W on high-velocity rotation, whereby the fed pure water can be dispersed uniformly over the entire upper surface of the wafer W. Thus, both surfaces of the wafer W are rinsed to wash the chemical liquid off the wafer.

After the rinse processing, the wafer W is rotated at a higher velocity (e.g., about 2000-3000 rpm) than rotated for the rinse processing, so as to be spin-dried. The three-way valve 51 may be changed over to the gas feed path 54 to flow N₂ gas (or heated hot N₂ gas) to the wafer undersurface. At this time, the lower side member 42 is also dried. In the spin-drying, the lower side member 42 is lowered to the retreat position B to feed at the retreat position B the N₂ gas to the wafer undersurface. For example, the lower side member 42 feeds the N₂ gas at the processing position A for the former 10 minutes, and for the latter 10 minutes, the lower side member 42 feeds the N₂ gas at the retreat position B. The lower side member 42 may be set on feeding the N₂ gas at the processing position A until the spin-drying is completed. On the other hand, the upper side feed nozzle 23 supplies the N₂ gas to the wafer upper surface. That is, the three-way valve 67 is changed over to the gas feed path 70 to flow the N₂ gas to the upper side feed path 66. Thus, both surfaces of the wafer W are rinsed, and drops of the pure water are removed from the wafer.

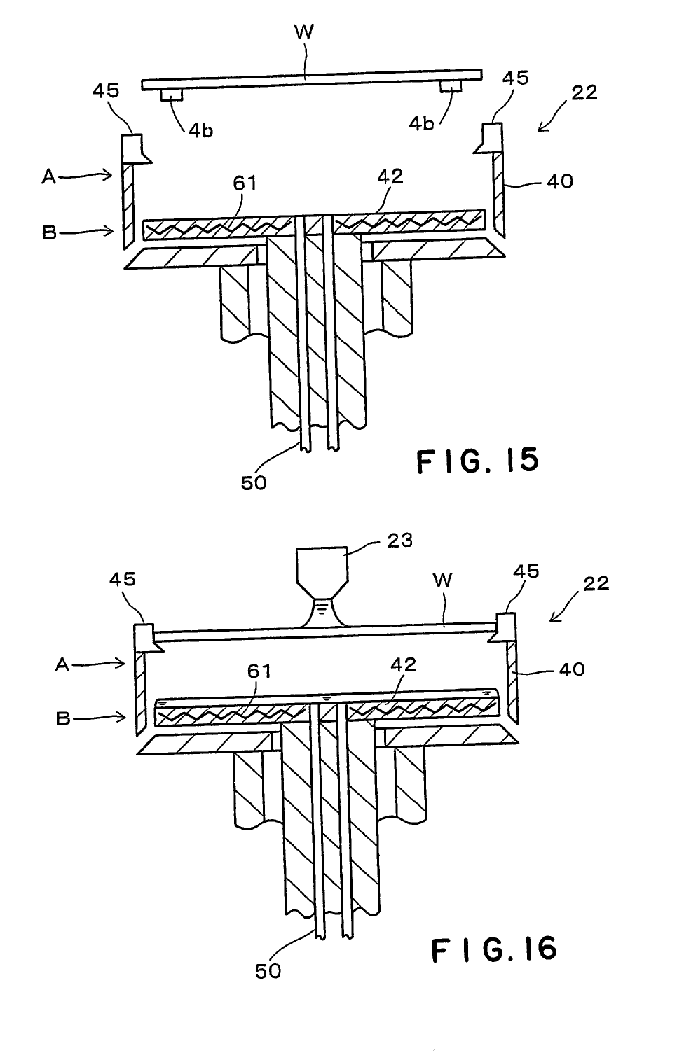

After the dry processing, the wafer W is unloaded out of the substrate processing apparatus 8. That is, as shown in FIG. 14, the transfer arm 4 advances, e.g., the arm 4b into the apparatus to support the undersurface of the wafer W with the arm 4b. Then, as shown in FIG. 15, the arm 4b is moved up to lift up the wafer W from the spin chuck 22 and is withdrawn out of the apparatus. At this time, the lower side member 42 is located at the retreat position B, and accordingly the sufficient gap is defined between the lower side member 42 and the position (height) of the wafer W held by the spin chuck 22, as was when the wafer W was loaded. The gap sufficiently allows the transfer arm 4 to receive the wafer W from the spin chuck 22.

In the above-described substrate processing apparatus, before a wafer W is loaded/unloaded, the lower side member 42 has been lowered to the retreat position, so that the transfer arm 4 can smoothly transfer the wafer W without contacting the lower side member 42. The upper side member 25 is kept from contacting the chemical liquid puddled on the upper surface of a wafer W, so that the contamination of the chemical liquid is prevented, and accordingly high cleaning ability can be maintained. The chemical liquid puddled on both surfaces of a wafer W is heated respectively to prescribed temperatures by the heaters 61, 76, so that the cleaning efficiency can be improved.

One example of preferred embodiments of the present invention has been described above, but the present invention is not limited to the embodiment described above. For example, in the present embodiment, the lower side member 42 feeds a chemical liquid into the gap L1 after the lower side member 42 has been moved to the processing position A. However, as exemplified in FIG. 16, a chemical liquid may be puddled on the lower side member 42 before the lower side member 42 is moved up to the processing position A (when the lower side member 42 is located at the retreat position B) to form the liquid film, and after the liquid film has been formed, the lower side member 42 may be moved up to the processing position A for the processing with the chemical liquid in contact with the wafer undersurface as shown in FIG. 11. In this case as well, the chemical liquid is held in the narrow gap L1, whereby the chemical liquid is uniformly contiguous to the entire undersurface of the wafer W for the suitable cleaning processing while the layer of the chemical liquid is prevented from collapsing.

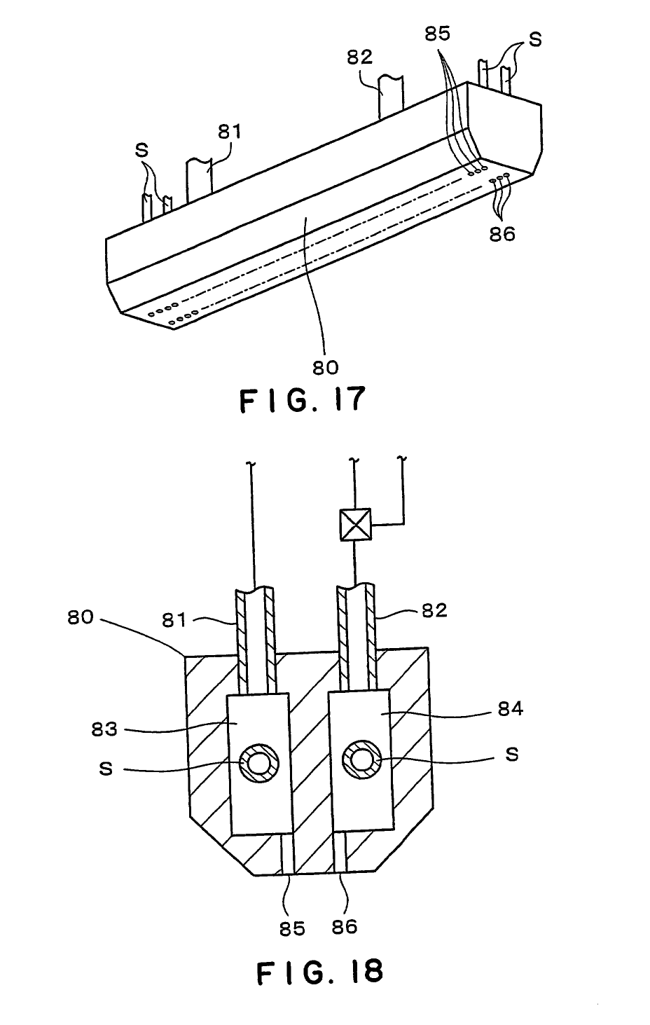

A modification of the upper side feed nozzle is exemplified in FIGS. 17 and 18. A chemical liquid feed path 81 for feeding a chemical liquid and a pure water/gas feed path 82 for feeding pure water and N₂ gas are respectively connected to the upper side of the upper side feed nozzle 18 shown in FIGS. 17 and 18. Inside the upper side feed nozzle 80, a chemical liquid reservoir 83 for temporarily storing the chemical liquid and a pure water reservoir 84 for temporarily storing the pure water are provided. The chemical liquid fed through the chemical liquid feed path 81 is stored in the chemical liquid reservoir 83 and then fed to the upper surface of a wafer W through a plurality of chemical liquid feed holes which are in communication with the chemical liquid reservoir 83. The pure water fed through the pure water/gas feed path 82 is temporarily stored in the pure water reservoir 84 and then fed to the upper surface of the wafer W through the plural pure water feed holes 86 which are in communication with the pure water reservoir 84. Temperature adjusting paths S are provided respectively in the chemical liquid reservoir 83 and the pure water reservoir 84 so as to separately adjust temperatures of the chemical liquid and the pure water.

It is possible that the upper side feed nozzle supplies the chemical liquid a lone, and a pure water feed nozzle for supplying pure water to the upper surface of the wafer W and a drying nozzle for supplying drying gas to the upper surface of the wafer W are separately provided so that the nozzles can be used corresponding to the kinds of the processing. Furthermore, the nozzle for supplying the chemical liquid can be a generally used feed nozzle having only one feed hole in place of the above-described upper side feed nozzle 23 having the plural feed holes provided longitudinally in one row.

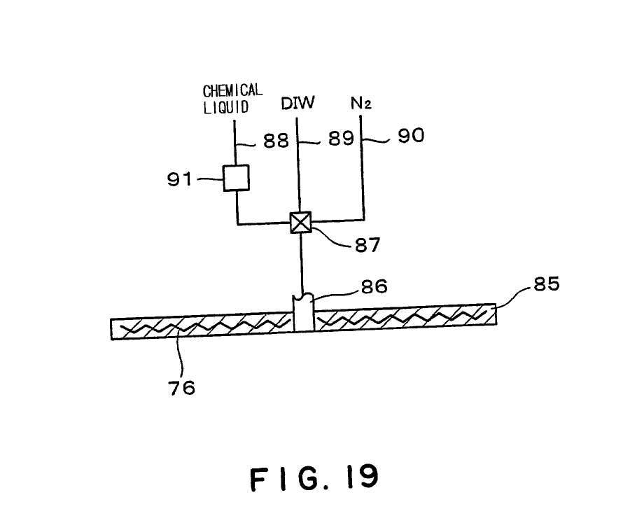

The processing from the chemical liquid processing to the drying processing may be continuously performed with the upper side member. That is, as shown in FIG. 19, the feed path 86 of a upper side member 85 is connected to a chemical liquid feed path 88, a pure water feed path 89 and a gas feed path 90 via a three-way valve 87. A temperature adjuster 91 is disposed in the chemical liquid feed path 88. The three-way valve 87 is changed over to the respective paths to feed a chemical liquid, pure water and N₂ gas to the upper surface of a wafer W, whereby the upper side member 85 may perform a lone the respective kinds of processing, and after the spin drying, liquid drops remaining on the wafer W may be dried by heating with the above-described heater 76.

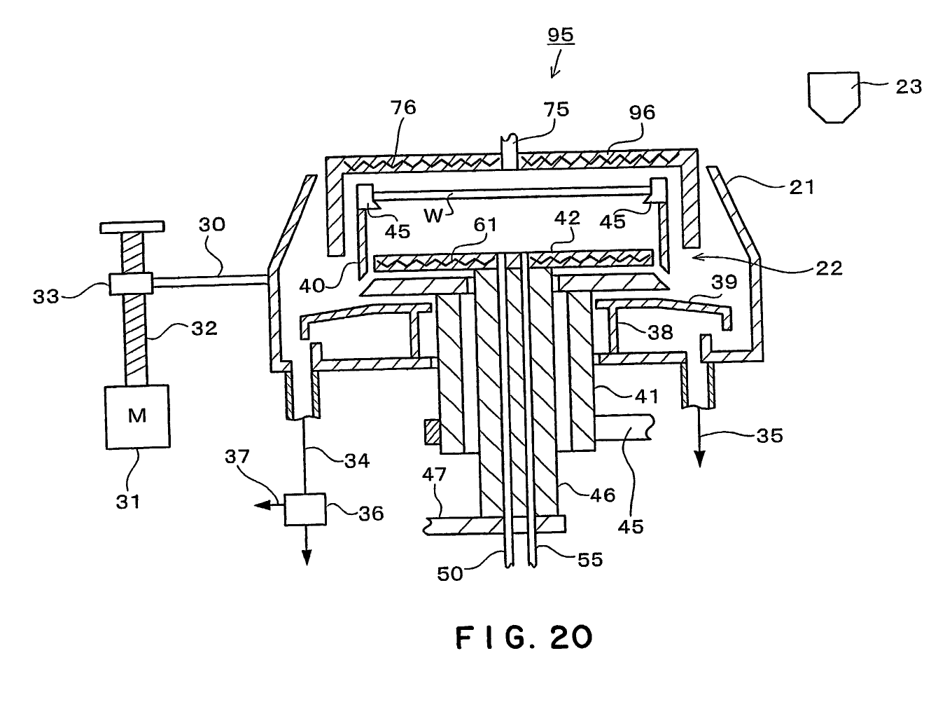

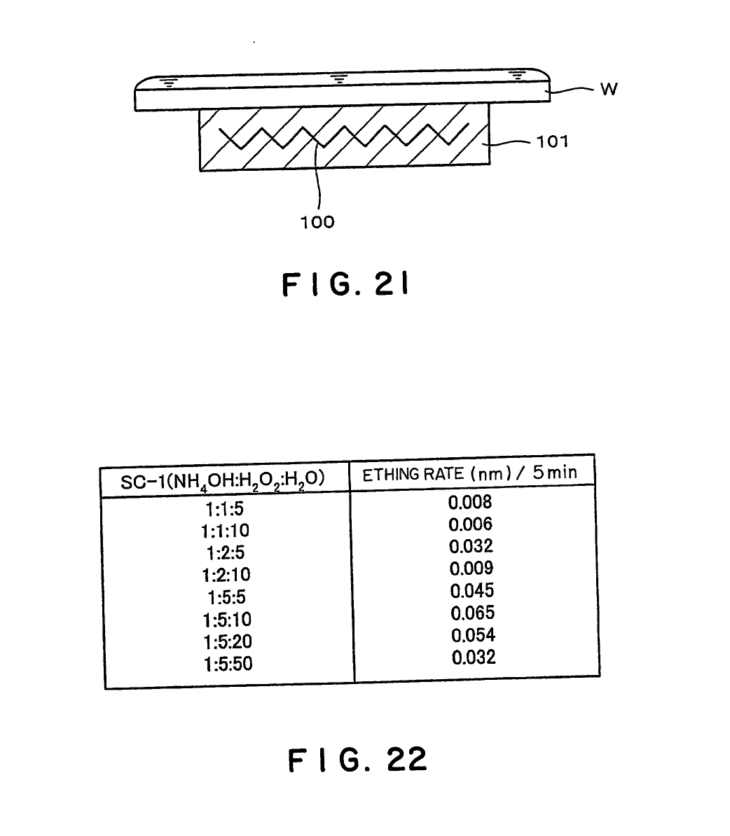

FIG. 20 shows the substrate cleaning apparatus 95 according to another embodiment of the present invention. The substrate cleaning apparatus 95 has a cylindrical upper side member 96 (cover) which can enclose the periphery of a wafer W held by the above-described spin chuck 22. The above-described heater 76 is buried in the upper side member 96, and the above-described chemical liquid feed path 75 is connected to the upper side of the upper side member 96. Except for the upper side member 96, the substrate cleaning apparatus 95 has substantially the same constitution as the substrate cleaning apparatus 8, and members of the present embodiment which are common with those of the above-described embodiment shown in FIG. 3 have the same reference numbers not to repeat their explanation.

In the substrate cleaning apparatus 95, for cleaning processing, the upper side member 96 is moved to a position in which the upper side member 96 is not contiguous to the liquid film of a chemical and which is adjacent to the upper surface of the wafer W, and encloses the periphery of a chuck body 40. With the wafer W enclosed by the upper side member 96, the evaporation of the chemical liquid can be further prevented. Furthermore, when a heater 76 is heated, the heat of the heater 76 is prohibited from escaping to the surroundings, and the liquid film of the chemical liquid formed on the upper surface of the wafer W can be adjusted to a prescribed temperature in a short period of time. An atmosphere in the chuck body 40 as well is prohibited from easily escaping, and an exhaust of the cup 21 can be smaller, with a result that a running cost, for example, can be low.

The present invention is not limited to substrate cleaning apparatuses using cleaning liquids and is applicable to apparatuses for performing processing other than the cleaning processing, using other various kinds of processing liquids, etc. The substrates are not limited to semiconductor wafers and can be glass substrates for LCDs, CD substrates, print substrates, ceramic substrates, etc.

### EXAMPLE

The present invention was tested. Removal amounts (etching rates) of the puddle cleaning which puddles a cleaning liquid on a wafer W to clean the wafer W will be evaluated.

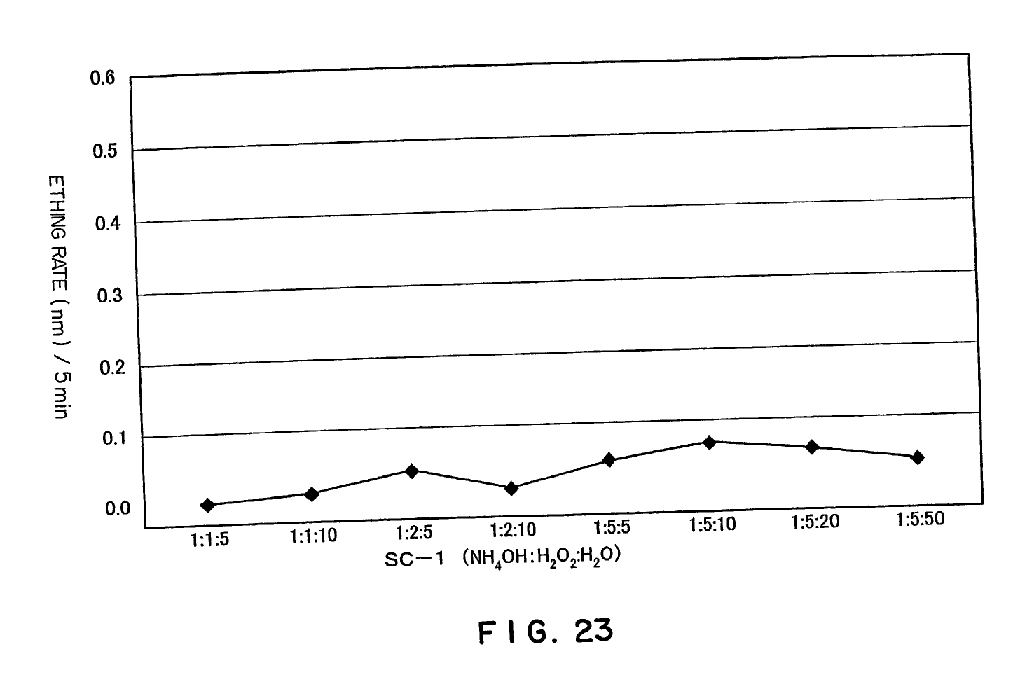

First, as shown in FIG. 21, an about 10 nm±0.3 nm thermal oxide film (Th-Oxide) was formed on a wafer, and the wafer W was placed on a mount 101 with a heater 10 buried in. A cleaning liquid heated to a prescribed temperature (e.g., 60° C.), e.g., APM(NH₄OH/H₂O₂/H₂O mixed liquid) was puddled on the thermal oxide film, and the wafer was subjected to SCI puddle cleaning at the room temperature. Mixed content ratios of the APM components, i.e., an aqueous solution of ammonium (NH₄OH) : aqueous hydrogen peroxide (H₂O₂) : pure water (H₂O) were changed sequentially, e.g., from 1:1:5, 1:1:10, 1:2:5, 1:2:10, 1:5:5, 1:5:10, 1:5:20 to 1:5:50 to investigate changes of removal amounts of the thermal oxide film. The film thickness was measured by an optical film thickness meter, such as an ellipsometer or others. A processing time was 5 minutes. Metered results were given by averaging metered values given at 9 metering points in plane of the wafer W. FIG. 22 shows the metered results. FIG. 23 shows a graph of the metered results.

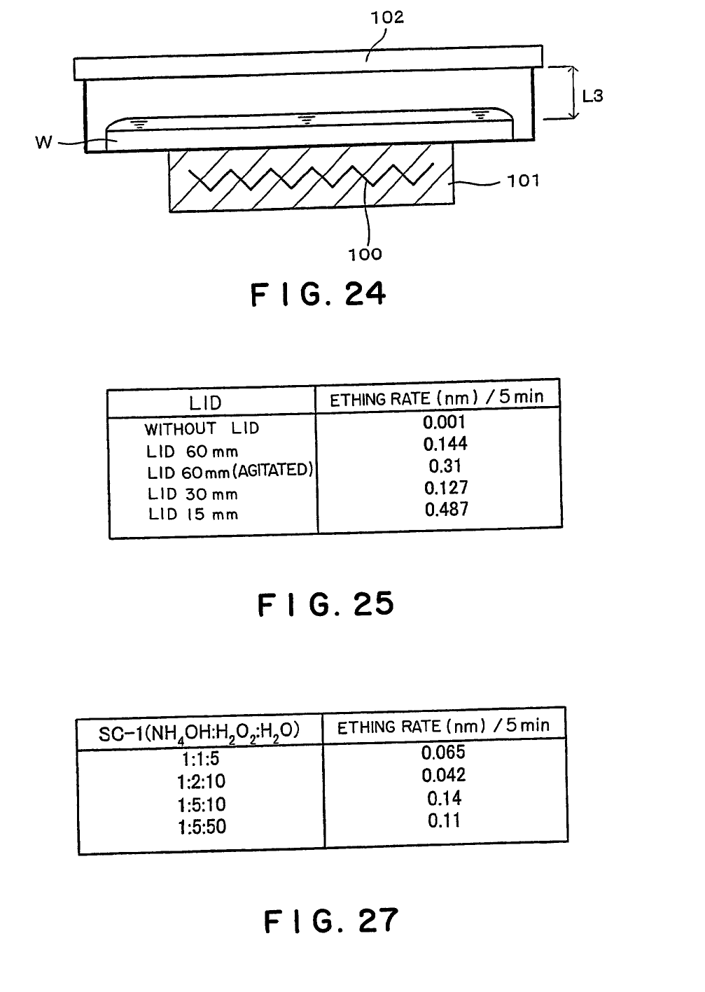

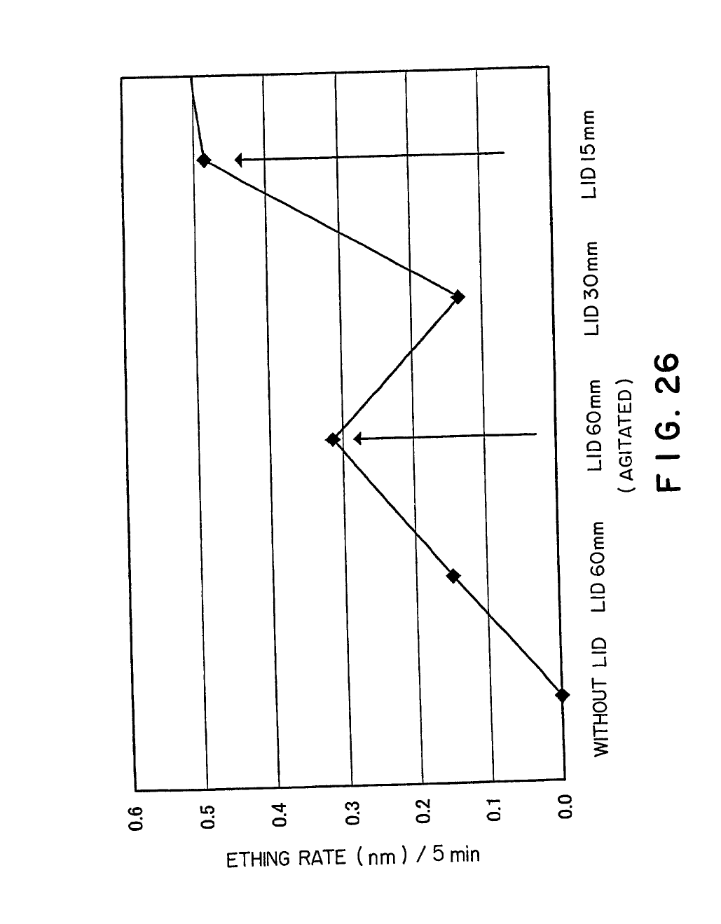

Then, as shown in FIG. 24, a lid 102 was disposed above the wafer W placed on the mount 101, and a gal L3 between the lid 102 and the wafer W were narrowed sequentially from 60 mm, 30 mm to 15 mm to thereby investigate changes of the removal amounts of the thermal oxide film. When the gal L3 was 60 mm, the mount 101 was rotated at a speed which did not collapse a configuration of the liquid film of the APM to agitate the APM inside of the APM film, and removal amounts of the thermal oxide film were investigated. Mixed content ratios of the APM components was fixed to 1:1:5 (an aqueous solution of ammonium : aqueous hydrogen peroxide:pure water). Metering conditions, such as a prescribed temperature of the APM, a film thickness meter, a processing time metering points, etc., were the same as those used in the above-described evaluation. The table of FIG. 25 shows the metered results. FIG. 26 shows a graph of the metered results.

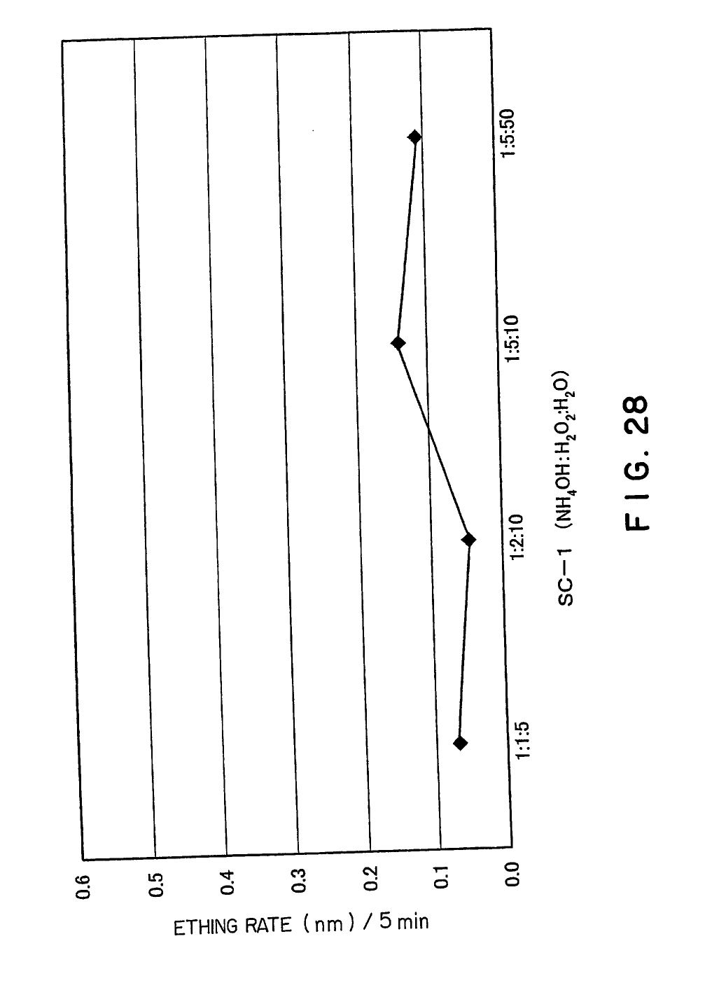

Next, the lid was disposed above the wafer W, and the heater 100 was heated to adjust the wafer W to a prescribed temperature (e.g., 60° C.) to investigate changes of removal amounts of the thermal oxide film. Mixed content ratios of the APM components were changed sequentially from 1:1:5, 1:2:10, 1:5:10 to 1:5:50. A gap L3 between the lid and the wafer W was fixed to 5 mm, and a processing time was 5 minutes. Conditions, such as a prescribed temperature of the APM, a film thickness meter, metering points, etc., were the same as those used in the above-described evaluation. The table of FIG. 27 shows metered results, and FIG. 28 shows a graph of the metered results.

As seen in these tables and graphs, the removal amount of the thermal oxide film is minimum when the wafer W is merely placed on the mount. When the lid and the temperature adjustment are combined, the removal amount is maximum. As shown in FIGS. 25 and 26, when the lid is disposed above the wafer W, the removal amount is larger as the gap L3 between the lid and the wafer is smaller. Furthermore, the agitation of the APM inside the liquid film of the APM by the rotation of the wafer W will generate liquid flows inside the liquid film to thereby increase the removal amount.

According to the present invention, when a substrate is loaded/unloaded, the lower side member has been lowered to the retreat position. The carriage arm, which loads/unloads, e.g., substrates, can load/unload substrates smoothly without contacting the lower side member. The upper side member does not contact the cleaning liquid puddled on the upper surface of a substrate. The cleaning liquid is prevented from contamination, and high cleaning ability can be maintained. Furthermore, the chemical liquid puddled on both surfaces of a substrate is adjusted to a prescribed temperature by the upper side temperature adjusting mechanism and the lower side temperature adjusting mechanism. The cleaning liquid can be prevented from evaporating, and the cleaning efficiency can be accordingly high.

The other embodiments of the present invention will be described below with reference to the drawings. In these embodiments, the cleaning system according to the present invention will be explained in reference to a case that the cleaning system is applied to a cleaning system comprising a cleaning unit that simultaneously cleans both the surfaces of a semiconductor wafer W.

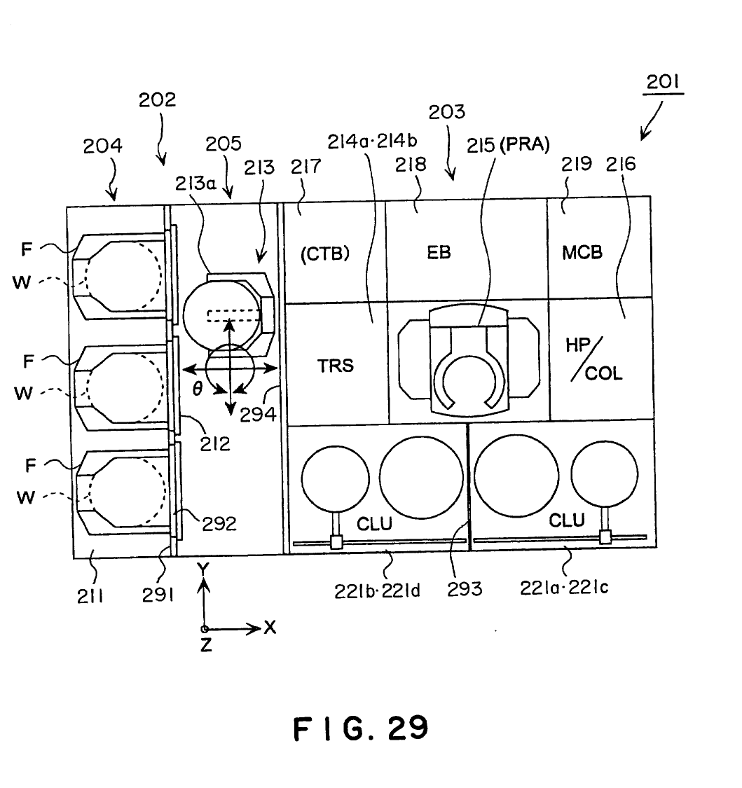

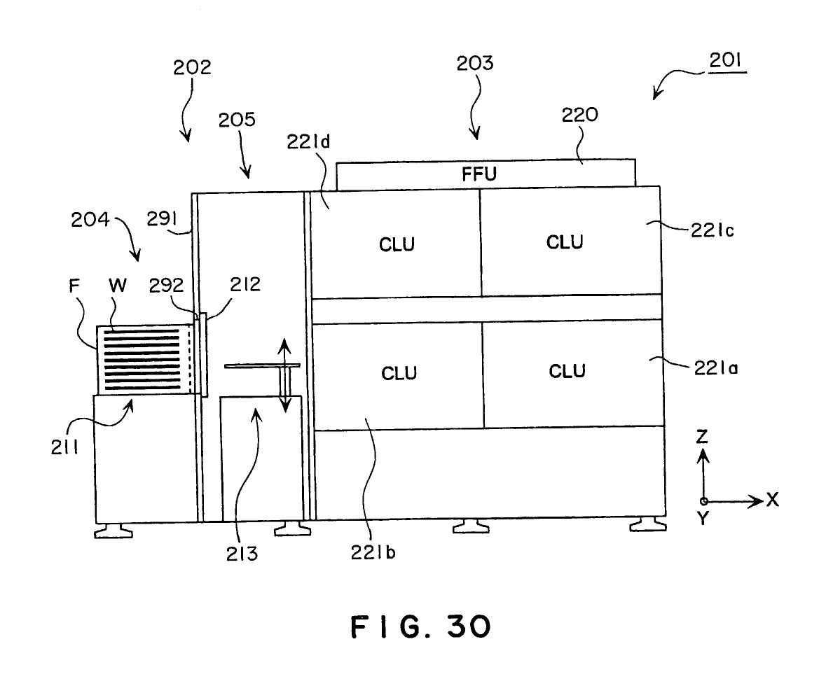

FIG. 29 is a plane view of a diagrammatic structure of a cleaning system 201 and FIG. 30 shows its side view. As shown in these FIG. 29 and FIG. 30, the cleaning system 201 comprises a cleaning module 203 which cleans a wafer W and then heats the same after cleaning and an entrance/exit module 202 which transfers a wafer W to and from the cleaning module 203. The entrance/exit module comprises an in/out port 204 equipped with a mount 211 to mount a container (a hoop F) which can keep a plurality of wafers, e.g., 25 sheets, in a substantially horizontal position at a specific interval and a wafer carrying module 205 equipped with a wafer carrying apparatus (CRA) 213 which transfers a wafer W between the hoop F mounted on the mount 211 and the cleaning module 203.

A wafer W is transferred through one side of the hoop F, and a cover member is disposed on this very side of the hoop F, which can be open and closed. Also as for the hoop F, there are shelves disposed on the inside walls in order to keep wafers W set with specific intervals, and a slot 1 to slot 25 are formed to retain wafers W. One wafer is retained in one slot with the front surface of the wafer (defined as a surface where a semiconductor device is formed) up (defined as an upper surface when a wafer is kept in a horizontal position).

On the mount 211 at the in/out port 204, three hoops F, for example, can be mounted at a specific position horizontally in a Y direction. The hoop F is mounted with its side on which the cover member is formed faced to a separating wall 291 separating the in/out port 204 from the wafer carrying module 205. On the separating wall 291, window portions 292 are formed in positions corresponding to the positions where the hoops F are disposed, and on the side of the window portion 292,where the wafer carrying module 205 is disposed, a window open/close mechanism 212 is installed to open and close the window portions 292 by shutters, etc.

The window open/close mechanism 212 also can open and close the cover members formed on the hoops F; it simultaneously opens and closes the cover member of the hoop F and the window portion 292. It is preferable to install an interlock on the window open/close mechanism 212 so as not to set in motion while the hoop F is not mounted at a specific position. Wafers can be ready to be transferred when the wafer carrying apparatus (CRA) 213 disposed in the wafer carrying module 205 gains access to the hoop F by opening the window portion 292 so that the entrance/exit of wafers W on the hoop F are open to the wafer carrying module 205. A wafer monitoring equipment, not shown, is installed above the window portion 292 to detect the amount and condition of wafers W retained by the slot in the hoop F. Such wafer monitoring equipment can be installed also on the window open/close mechanism 212.

The wafer carrying apparatus (CRA) 213 disposed in the wafer carrying module 205 is arranged to be able to shift in Y direction and Z direction and rotate within an X-Y plane. Also the wafer carrying apparatus (CRA) 213 has a carriage arm 213a to hold a wafer W, which can slide in X direction. In this way, the wafer carrying apparatus (CRA) 213 has access to a slot at selected height in each hoop F mounted on the mount 211 and also has access to two wafer transfer units (TRS) 214a and 214b disposed in the cleaning module 203; thus, the wafer carrying apparatus (CRA) 213 can carry wafers W from the side of the in/out port 204 to the side of the cleaning module 203 and vise versa: from the side of the cleaning module 203 to the side of the in/out port 204.

The cleaning module 203 comprises two wafer transfer units (TRS) 214a and 214b which temporarily retain wafers W to transfer wafers W to and from the wafer carrying module 205; four cleaning units (CLU) 221a-221d which simultaneously clean the upper surface and the undersurface of wafers W; a hotplate/cooling unit (HP/COL) 216 comprising three hotplate units (HP) 216a-216c which heat up wafers W after cleaning and a cooling unit (COL) 216d which cools down the heated wafers W; and a main wafer-carrying apparatus (PRA) 215 which is installed to approach all the units including the wafer transfer units (TRS) 214a and 214b, the cleaning units (CLU) 221a-221d and the hotplate/cooling unit (HP/COL) 216 to carry wafers W from every unit to unit.

The cleaning module 203 is equipped with an electric equipment unit (EB) 218 which is a power source to operate the entire cleaning system 201; a machine control unit (MCB) 219 which functions and controls every unit disposed in the cleaning system 201 and the cleaning system 201 as a whole; and a chemical liquid retaining unit (CTB) 217 which retains specific cleaning liquid to be provided for the cleaning units (CLU) 221a-221d. The electric equipment unit (EB) 218 is connected to a primary power source, not shown. At the ceiling part of the cleaning module 203, a filter fan unit (FFU) 220 is installed so that pure air can downflow to the main wafer-carrying apparatus (PRA) 215 and every unit that treats wafers W.

By installing the chemical liquid retaining unit (CTB) 217, electric equipment unit (EB) 218 and machine control unit (MCB) 219 outside or out of the cleaning module 203, maintenance of the wafer transfer units (TRS) 214a and 214B, main wafer-carrying apparatus (PRA) 215 and hotplate/cooling unit (HP/COL) 216 can be easily maintained from this side (the side in Y direction).

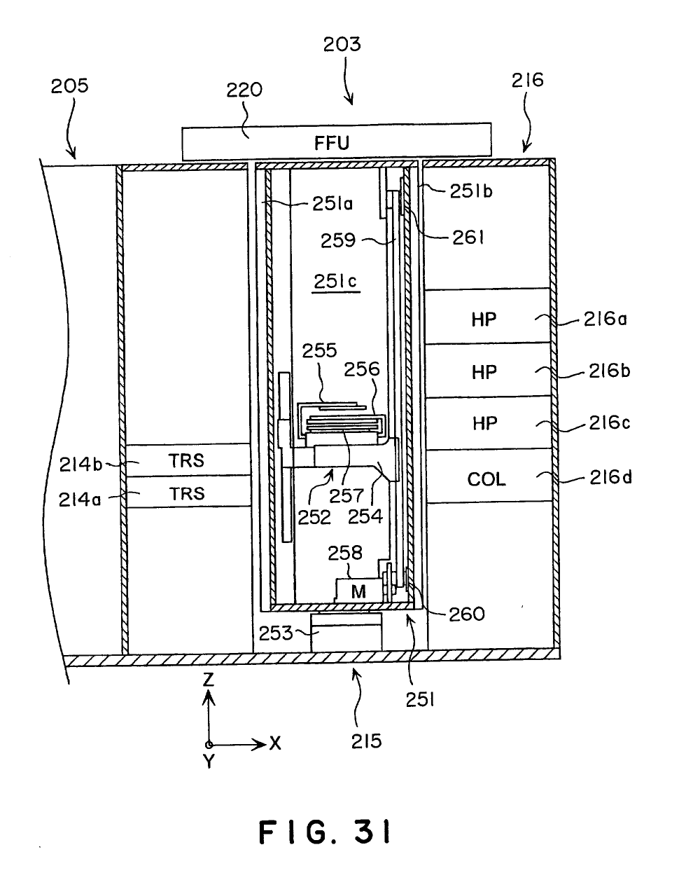

FIG. 31 is a cross-sectional view of a diagrammatic position of the wafer transfer units (TRS) 214a and 214b, the main wafer-carrying apparatus (PRA) 215 adjacent in X direction to the wafer transfer units (TRS) 214a and 214b and the hotplate/cooling unit (HP/COL) 216. The wafer transfer units (TRS) 214a and 214b are vertically piled up, so the lower wafer transfer unit (TRS) 214a can be used, for example, to retain a wafer w which is transferred from the in/out port 204 to the cleaning module 203 while the upper wafer transfer unit (TRS) 214b is used to retain a wafer W which is transferred from the cleaning module 203 to the in/out port 204.

The cleaning system is constructed to flow out some downflow from the filter fan unit (FFU) 220 toward the wafer carrying module 205 through the wafer transfer units (TRS) 214a and 214b and the open space above the wafer carrying module. Consequently, contamination by particles, etc. from the wafer carrying module 205 to the cleaning module 203 is prevented and cleanliness of the cleaning module 203 is maintained.

The main wafer-carrying apparatus (PRA) 215 extends in Z direction and comprises a tubular support 251 furnished with vertical walls 251a and 251b and a side opening 251c there-between and a wafer carrier 252, inside the tubular support 251, formed to shift upward and downward in Z direction along the tubular support 251. The tubular support 251 can rotate by means of rotation drive through a motor 253, and accordingly the wafer carrier 252 rotates together.

The wafer carrier 252 comprises a carriage base 254 and three primary wafer-carrying arms 255, 256 and 257, all of which can shift back and forth parallel to the carriage base 254, and the primary wafer-carrying arms 255 to 257 have such sizes to pass through the side opening 251c on the tubular support 251. These primary wafer-carrying arms 255 to 257 a removable to advance and retreat individually by means of the built-in motor and belt mechanism inside the carriage base 254. The wafer carrier 252 shifts upward and downward by a belt 259 driven by a motor 258. Additionally, the reference 260 is a driving pulley and 261 is a driven pulley.

The hotplate/cooling unit (HP/COL) 216 comprises one cooling unit (COL) 216d to compulsively cool down wafers W and three hotplate units (HP) 216a to 216c mounted thereon to compulsively heat up and naturally cooldown wafers W. Other wise, the hotplate/cooling unit (HP/COL) 216 can be disposed in a space above the wafer transfer unit (TRS) 214a and 214b. In this case, the space for the hotplate/cooling unit (HP/COL) 216 shown in FIG. 29 can be utilized for a space for other utilities.

The cleaning units 221a to 221d are disposed on two shelves of the upper and the lower, mounting 2 units for each shelf. As shown in FIG. 29, the cleaning units 221a and 221c and the cleaning units 221b and 221d are arranged symmetrically with respect to a wall 293; however, the function of each mechanism constituting the cleaning units 221a to 221d has no difference. Then, the mechanism will be explained in detail below exemplifying the cleaning unit (CLU) 221a. The symmetric structure enables the main wafer-carrying apparatus (PRA) 215 to make the primary wafer-carrying arms 255 to 257 advance to and retreat from the cleaning unit (CLU) 221a to 221d without shifting in X direction.

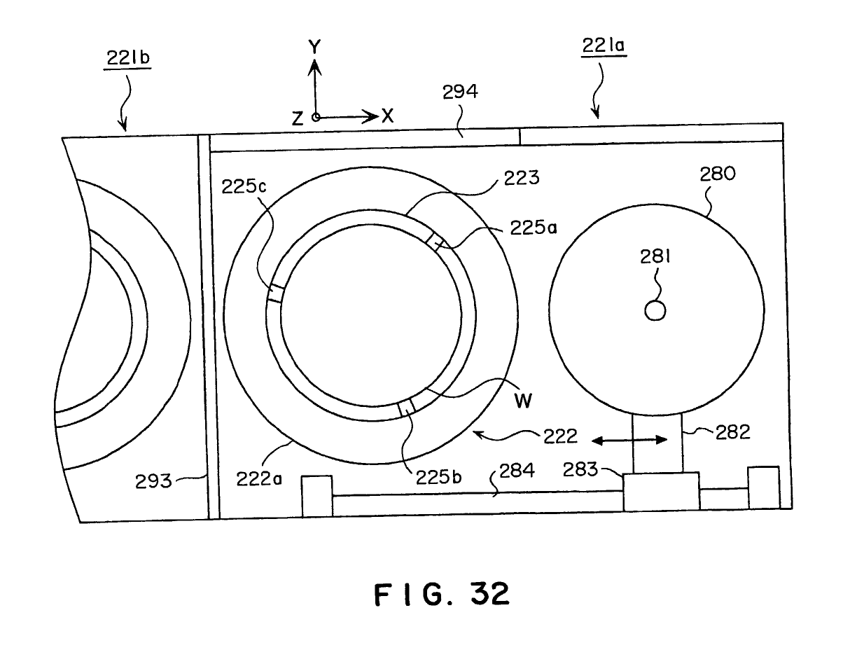

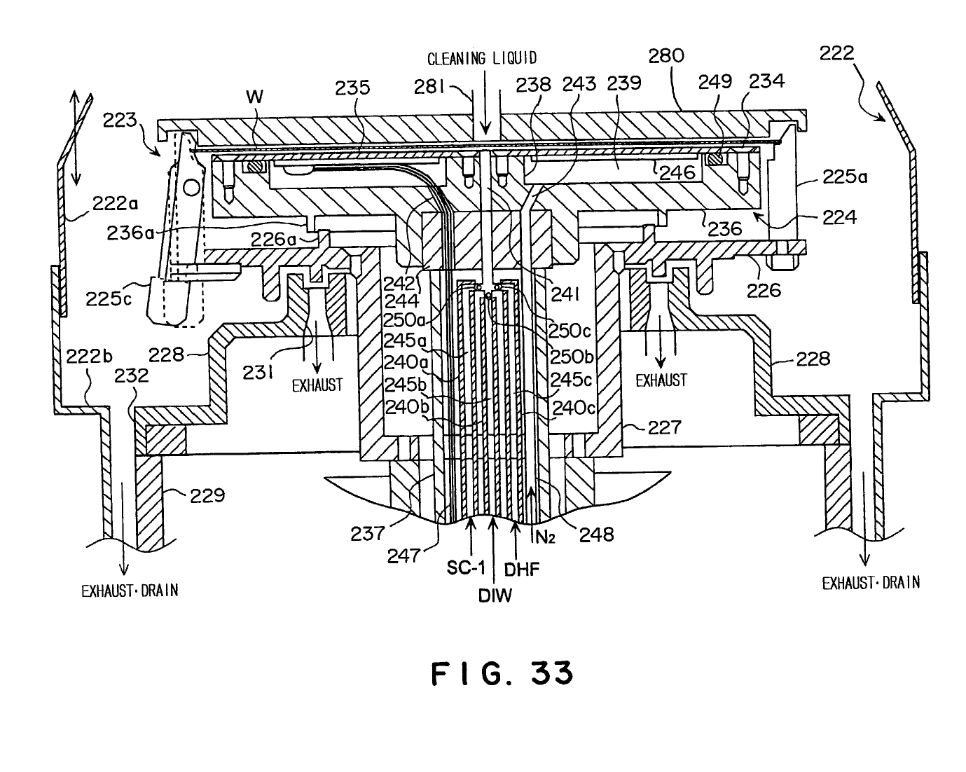

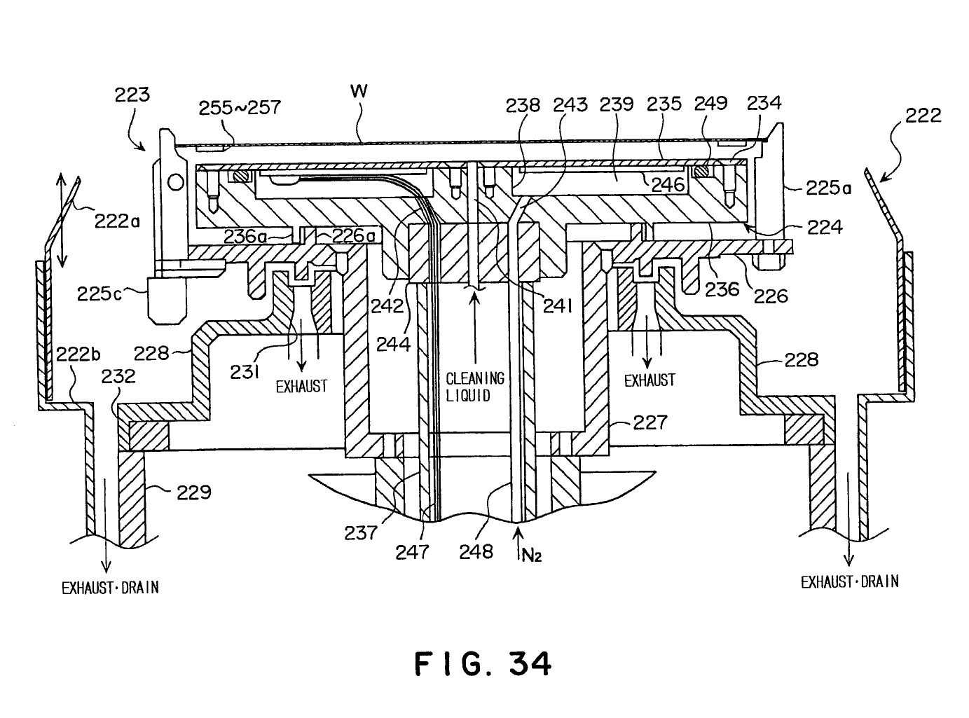

FIG. 32 is a plane view of a diagrammatic structure of the cleaning unit (CLU) 221a, FIG. 33 and FIG. 34 are both diagrammatic sectional views showing a processing cup 222 installed in the cleaning unit (CLU) 221a and its structure inside, FIG. 33 shows a state of cleaning a wafer W and FIG. 34 shows a state of loading and unloading a wafer W. The cleaning unit (CLU) 221a has a window portion 294 formed near the separating wall 293 for the primary wafer-carrying arms 255 to 257 to enter and exit, and the window portion 294 can be open and closed by a shutter, not shown.

The cleaning unit (CLU) 221a comprises a processing cup 222 and a cover member(upper side member) 280 which is disposed to cover the upper surface of a wafer W held inside the processing cup 222 and is movable, and inside the processing cup 222, a spin chuck 223 is disposed to hold a wafer W in a substantially horizontal position and a stage(lower side member) 224 is disposed to be positioned below a wafer W held by the spin chuck 223.

At the substantial center of the cover member 280, a cleaning liquid discharge opening(a second processing liquid discharge opening of a second processing liquid feed path) 281 is formed to feed a specific cleaning liquid onto the surfaces of a wafer W held by the spin chuck 223, and the cover member 280 can freely slide in X direction by a slide mechanism, not shown, along a guide 284 which is extended in X direction and also lift upward and downward in Z direction by a lift mechanism, not shown.

A wafer W is held by its side with holding members 225a to 225c formed at three points on the outer circumferential portion of the spin chuck 223. As shown in FIG. 33, the holding member 225c can be tilted inwardly; a wafer W can be locked and unlocked by the tilting movements when the wafer W is transferred between the primary wafer-carrying arm 255 to 257 and the spin chuck 223. A chuck plate 226 on which the holding members 225a to 225c are mounted is disposed on a rotating shaft 227 which can rotate by a rotation mechanism, not shown, and is hollow, and a wafer W can be rotated by rotating the rotating shaft 227 at a specific rotation speed with the wafer W being held by the holding members 225a to 225c.

Below the chuck plate 226, a terraced cover 228 is formed surrounding the rotating shaft 227, and the cover 228 is fixed to a pedestal 229. Vents 231 are formed on the side of the internal circumference of the cover 228, and by vacuuming the air inside the processing cup 222 by an exhaust pump, etc., not shown, particles, etc. arisen by the rotation of spin chuck 223 are prevented from ascending above the wafer W and also a mist, etc. produced by a cleaning liquid which is spun off from the wafer W is prevented from diffusing outside the processing cup 222. The stage 224 is mainly comprises a stage main body portion 236, a disk 235 which is mounted by screws 234 to cover the upper side of the stage main body portion 236, a spindle 237 to support the stage main body portion 236 and a lift mechanism, not shown, which is disposed below the spindle 237, and the stage 224 can be shifted upward and downward to a specific height by operating the lift mechanism. FIG. 33 shows the stage 224 held to the position (a processing position), where a wafer W is cleaned, by operating the lift mechanism.

When a wafer W is transferred between the spin chuck 223 and a primary wafer-carrying arm 255 to 257, the stage 224 is lowered to a position (a retreating position) wherein a circular projection 236a formed on the undersurface of the stage main body portion 236 makes contact with the upper surface of the chuck plate 226 and a circular projections 226a formed on the upper surface of the chuck plate 226 makes contact with the undersurface of the stage main body portion 236 at the same time, as shown in FIG. 34. By widening the width of a space between a wafer W and a disk 235 in this way, the main wafer-carrying arms 255 to 257 can easily enter and exit.

A circular groove 238 is formed on the side of the upper surf ace of the stage main body portion 236, and the disk 235 covering the groove 238 forms a cavity 239. Also, a cylindrical concavity is formed at the center of the undersurface of the stage main body portion 236, and a cylindrical member 244 is mounted to fit the concavity and the undersurface of the cylindrical member 244 is joined to the upper surface of the spindle 237. A cleaning liquid discharge opening(a second processing liquid discharge opening of a second processing liquid feed path) 241 is formed by piercing the substantial center of the disk 235, the stage main body portion 236 and the cylindrical member 244, and a specific cleaning liquid is provided into the cleaning liquid discharge opening 241 through cleaning liquid feed pipes(processing liquid feed pipes) 245a to 245c disposed to the cylindrical member 244, and then the cleaning liquid is fed into a space between the surface of the disk 235 and a wafer W.

The cleaning liquids include, for example, a chemical liquid called SC-1 used mainly for removing particles, which is a mixed liquid of ammonium hydroxide (NH₄OH), hydrogen peroxide (H₂O₂) and pure water (DIW) (composition ratio is NH₄OH:H₂₀2:DIW =1:2:10 ˜1:5: 50); a chemical liquid called DHF used mainly for removing oxide films, which is a water solution including a specific amount of hydro-fluoric acid; and pure water (DIW).

In the cleaning unit 221a, SC-1 is provided from the cleaning liquid feed pipe 245a, pure water (DIW) is provided from the cleaning liquid feed pipe 245b and DHF is provided from the cleaning liquid feed pipe 245c, and check valves 250a to 250c are disposed respectively to the cleaning liquid feed pipes 234a to 245c near the parts where these cleaning liquid feed pipes 245a to 245c join. These check valves 250a to 250c prevent different kinds of cleaning liquids from flowing in to the cleaning liquid feed pipes 234a to 245c. In FIG. 34, detailed illustration of the cleaning liquid feed pipes 245a to 245c is omitted.

The cleaning liquid feed pipes 245a to 245c are equipped with heaters 240a to 240c disposed respectively so that the temperature of processing liquids provided to a space between a wafer W and the disk 235 can be controlled to have an adequate liquid temperature for each processing liquid. In addition, at the cavity 239, a heater 246 is disposed on the undersurface of the disk 235, and the temperature of processing liquids provided to a space between the disk 235 and a wafer W can be controlled also by the heater 246. A cable 247 to provide electricity for the heater 246 is passed through an electric wire hole 242 which is formed to run through the cavity 239 and the hollow part of the spindle 237. Cleaning liquids can be quickly heated up to the adequate temperature by, for example, disposing the heater 246 on the undersurface of the disk 235 to cover the ceiling of the cavity 239 in order to widen the area for conducting heat to the disk 235.

The temperature of cleaning liquids provided to a space between the disk 235 and a wafer W can be controlled only by the heater 246; however, by adding the heaters 240a to 240c, load of the heater 246 is reduced, and also the temperature of a cleaning liquid can become more even. By keeping a cleaning liquid at a specific temperature in this way, efficiency of the cleaning liquid is improved and more highly accurate cleaning can be achieved.

At the stage 224, a gas feed opening 243 is formed running through the cavity 239 and the hollow part of the spindle 237, and a gas feed pipe 248 is mounted to the gas feed opening 243. By supplying inert gas, such as dried nitrogen gas, to the cavity 239 through the gas feed opening 243, a cleaning liquid is kept from entering into the cavity 239 from a space between the screw 234 and the disk 235 or other spaces through a sealing 249 between the disk 235 and the stage main body portion 236.

The processing cup 222 comprises an inside cup 222a which is able to move upward and downward by a lift mechanism, not shown, and an under cup 222b which is fixed. When cleaning a wafer W, the inside cup 222a is held to the position shown in FIG. 33 upper position) to prevent the cleaning liquid which is spun off from the wafer W from scattering outside. On the contrary, the inside cup 222a is held to the position shown in FIG. 34 (lower position) when a wafer W is transferred between the primary wafer-carrying arms 255 to 257 and the spin chuck 223 in order to enable the primary wafer-carrying arms 255 to 257 to enter and exit. On the bottom of the under cup 222b, a drain 232 is formed for exhaustion and discharge of cleaning liquids.

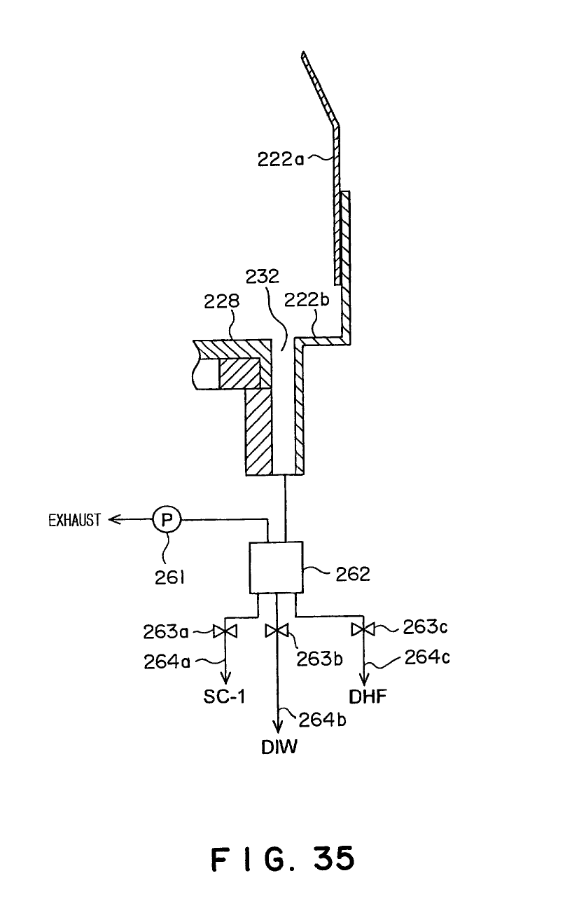

In a case that SC-1, DHF and pure water (DIW) are used as cleaning liquids as described above, these liquids have to be collected separately when collecting the cleaning liquids from the drain system 232 in order to avoid a chemical reaction caused by SC-1 and DHF as a minimum, since SC-1 is an alkaline solution including ammonium hydroxide; whereas, DHF is an acid solution including hydro-fluoride. FIG. 35 is an explanatory diagram showing a drain route of the drain system 232 to collect SC-1 and DHF separately wherein an exhaust pump 261 is disposed to the drain system 232 to compulsively exhaust and discharge the cleaning liquids.

A mist separator 262 is disposed on the upper-stream of the exhaust pump 261 so that a cleaning liquid does not reach the exhaust pump 261, and a processing liquid separated by the mist separator 262 is released through drain pipes 264a to 264c to which electromagnetic valves 263a to 263c are respectively disposed. For example, in a case that SC-1 is used as a cleaning liquid, the used SC-1 is collected by opening the electromagnetic valve 263a of the drain pipe 264a which is to release SC-1 . Also, mixture of SC-1 and DHF in the mist separator 262 can be avoided by not consecutively providing SC-1 and DHF and by ensuring that SC-1 or DHF is rinsed off with pure water (DIW) every time after SC-1 or DHF is used.

While a wafer W is not being cleaned, the cover member 280 stays disengaged in a position away from the upper processing cup 222, as shown in FIG. 32. The cover member is held by the cover member support arm 282, and the cover member support arm 282 is connected to an arm holding member 283 which is fixed on the guide 284. The arm holding member 283 can slide in X direction by a driving mechanism, not shown, along a guide 284 and also the cover member 280 can lift upward in Z direction by a lift mechanism, not shown.

Thus, while a wafer W is being cleaned, as shown in FIG. 33, the cover member 280 is positioned and held to have a specific space between the wafer W and the undersurface of the cover member 280. In this state, a specific cleaning liquid is provided through the cleaning liquid discharge opening 281 formed in the substantial center of the cover member 280 to the upper surface of the wafer W held by the spin chuck 223 so that a puddle of the cleaning liquid which has no contact with the cover member 280 is formed on the upper surface of the wafer W or a layer of the cleaning liquid is formed in a space between the cover member 280 and the wafer W. A puddle of the cleaning liquid which has no contact with the cover member 280 can also be formed on the upper surface of the wafer W by lifting up the cover member 280 for a specific distance after a cleaning liquid layer is formed in a space between the wafer W and the cover member 280.

In the case that a cleaning liquid layer is formed in a space between the cover member and the wafer W, it is also preferable to control the temperature of the chemical liquid provided to a space between the cover member 280 and the wafer W by installing a heater inside the cover member 280 in the same way as controlling the temperature of a chemical liquid provided to a space between the disk 235 and a wafer W by the heater 246. Additionally, it is preferable that a cleaning liquid feed pipe, not shown, to feed a specific cleaning liquid into the cleaning liquid discharge opening 281 is structured to be able to control the temperature by a heater in the same way as the cleaning liquid feed pipes 245a to 245c as described above. By keeping a cleaning liquid at a specific temperature in this way, efficiency of the cleaning liquid is improved and more highly accurate cleaning can be achieved.

In the case that a puddle of the cleaning liquid which has no contact with the cover member 280 is formed on the upper surface of the wafer W, evaporation of the processing liquid can be prevented by setting the cover member 280 at a specific position above the wafer W. Also, the puddle formed on the wafer W can be heated indirectly by installing a heater inside the cover member 280 and keeping the cover member 280 at a specific temperature.

In order to evenly clean the undersurface of a wafer W when cleaning a wafer W using the above-described cleaning unit (CLU) 221a, a layer has to be formed in a space between a wafer W and a disk 235 for the undersurface of the wafer W to make contact with the cleaning liquid evenly. Generally, metal materials,such as aluminum, stainless, etc., are used to form a disk 235, but the contact angle of these metal materials when contacting pure water is as narrow as about 8°. Consequently, in a case that the surface of the disk 235 is made of these metal materials, it is difficult to form a layer of a chemical liquid in a space between a wafer W and the disk 235 by feeding a cleaning liquid into a space between the wafer W and the disk 235 unless the distance therebetween is shortened.

Therefore, a disk 235 according to the present invention is treated to have a hydrophobic property to cleaning liquids by coating a hydrophobic resin, such as a fluorocarbon resin, a hydrophobic silicone resin, etc., on its surface to make the surface of the disk 235 hydrophobic; whereas, the body thereof is structured by metal materials. Consequently, a puddle with height can be formed on the surface of a disk 235, and a cleaning liquid layer can be formed in a space between the disk 235 and a wafer W without fail, and moreover, a puddle of a cleaning liquid can be formed so as to cover up the entire wafer W. Preferably, a disk 235 which satisfies the condition that a cleaning liquid come into contact with the surface of the disk 235 at a contact angle of not less than 50° is used.

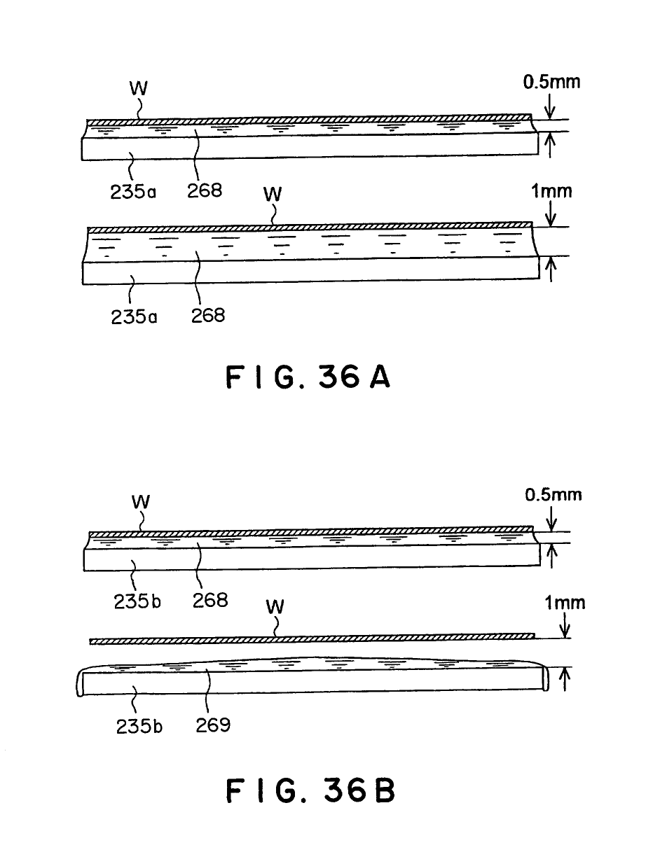

FIG. 36A and FIG. 36B are explanatory drawings which diagrammatically show the states that a layer of a cleaning liquid (SC-1) is formed in a space between a wafer W and a disk 235a wherein the disk 235a is coated with a fluorocarbon resin on the surface thereof to form a fine resin layer, not shown, and a layer of a cleaning liquid (SC-1) is formed in a space between a wafer W and a disk 235b wherein the disk 235b has no coating thereon. As shown in FIG. 36A, in a case that a disk 235a with a resin layer formed thereon is used, an ample cleaning liquid layer 268 is formed in a space between the disk 235a and a wafer W, not only when the width of the space between the disk 235a and a wafer W is 0.5 mm but also 1 mm. The undersurface of a wafer W which is cleaned by being left for a specific time in this condition has few particles remained, and the remained particles are evenly dispersed.

On the other hand, as shown in FIG. 36B, in a case that a disk 235b without a fluorocarbon resin coated on the surface thereof is used, an ample cleaning liquid layer 268 is formed in a space between the disk 235b and a wafer W when the width of the space between the disk 235b and the wafer W is 0.5 mm; however, when the width of the space is 1 mm, no ample cleaning liquid layer 268 is observed from the outer circumferential view of the disk 235b, and instead, a puddle is formed with the cleaning liquid flowing outward from the surface of the disk 235b. Caused by this condition, although the amount of the particles remained on the central part of the undersurface of the wafer W is small, particles remained at the outer circumferential part thereof is large in amount, and besides, unevenly dispersed.

As for the upper surface of a wafer W, since a puddle of a cleaning liquid is settled basically in accordance with wettability of the surface of the wafer W when contacting the cleaning liquid and the surface tension of the cleaning liquid, the width of a space between the wafer W and the cover member 280 is determined corresponding to the height of the puddle formed under these conditions. However, in a case that a cleaning liquid layer is formed in a space between a wafer W and the cover member 280, it is considered that wettability of the undersurface of the cover member 280 when contacting the cleaning liquid affects on the condition of forming the cleaning liquid layer in some degree. Also, since the cleaning liquid stays on the undersurface of the cover member 280 in the case that the undersurface of the cover member 280 makes contact with the cleaning liquid, particles, etc. are likely to stay on the undersurface of the cover member 280 unless a means is arranged for shaking off the cleaning liquid staying thereon. When the next wafer processing is started, the remaining particles on the undersurface of the cover member 280 can be mixed in to the cleaning liquid and cause a possible contamination of the wafer W.

Therefore, it is preferable to use a cover member 280 which is treated to have a hydrophobic property to cleaning liquids in accordance with the present invention; by coating a hydrophobic resin, such as fluorocarbon resin, hydrophobic silicon resin, etc., on the undersurface of the cover member 280, the undersurface of the cover member 280 becomes hydrophobic so that it is hydrophobic as well to cleaning liquids, such as pure water, etc. Consequently, the amount of staying particles, etc. can be reduced by reducing the amount of cleaning liquids staying on the undersurface of the cover member 280, and quality of liquid processing can be improved. Additionally, it is preferable that the cleaning liquid comes into contact with the undersurface of the cover member 280 at a contact angle of not less than 50°.

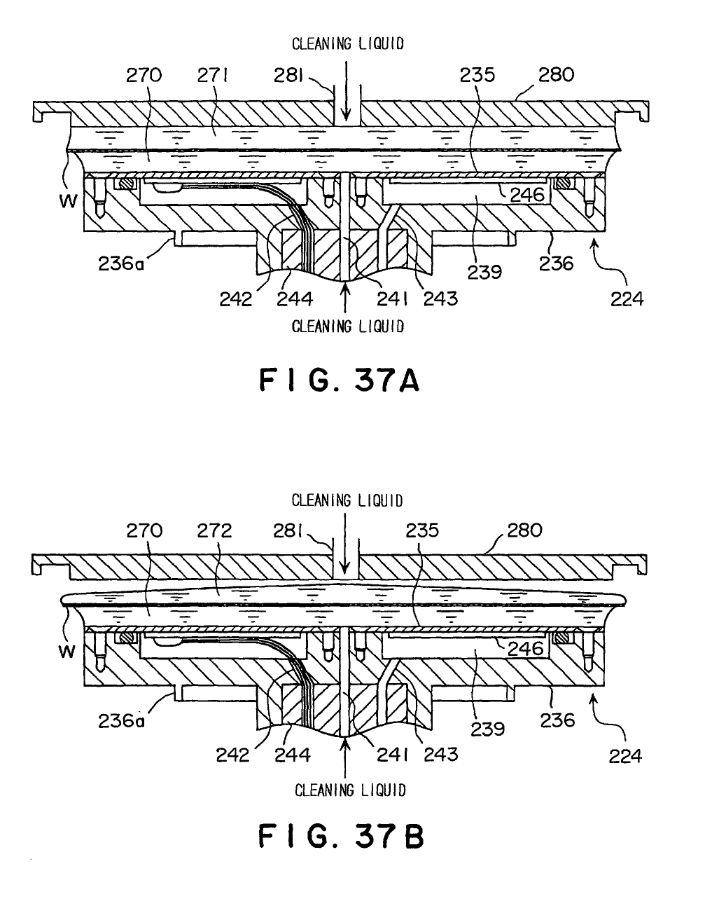

FIG. 37A and FIG. 37B are explanatory drawings showing the chemical liquid processing for a wafer W by the cleaning unit (CLU) 221 a with the disk 235 having a hydrophobic surface according to one embodiment of the present invention. FIG. 37A shows a state that a chemical liquid layers 270 and 271 are formed in spaces between the disk 235 and a wafer W and between the cover member 280 and the wafer W, and FIG. 37B shows a state that a chemical liquid puddle 272 is formed on the upper surface of a wafer W and a chemical liquid layer 270 is formed in a space between the disk 235 and a wafer W.

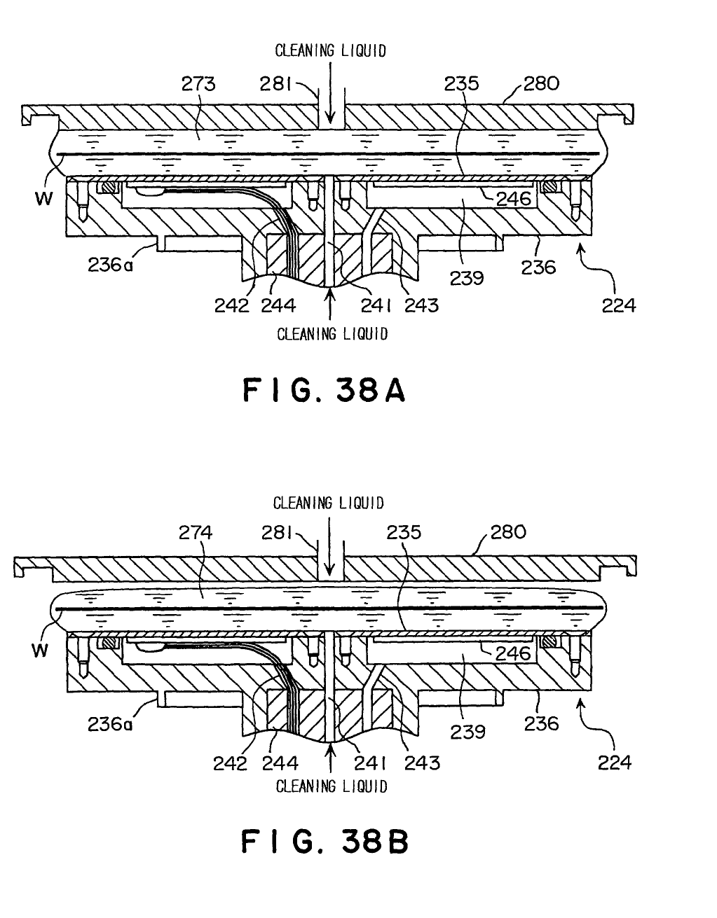

In addition, FIG. 38A and FIG. 38B are explanatory drawings showing another embodiment of a chemical liquid processing for a wafer W by the cleaning unit (CLU) 221a with the disk 235 having a hydrophobic surface. FIG. 38A shows a state that a chemical liquid layer 273 is formed in a space between the disk 235 and the cover member 280 to cover up the entire wafer W, and FIG. 38B shows a state that a chemical liquid puddle 274 is formed on the surface of the disk 235 to cover up the entire wafer W.

Specifically, the below-described steps are to be taken to make a wafer W entirely covered with the chemical liquid layer 273 a chemical liquid puddle 274; i.e., a puddle or a layer of a processing liquid is formed on the upper surface of the wafer W and also a layer of the processing liquid is formed in a space between the undersurface of the wafer W and the disk 235, and then the wafer W is rotated at a low rotation speed so that the processing liquid on the upper surface of the wafer W and the processing liquid puddle on the undersurface of the wafer W extend beyond the edge by a centrifugal force and make contact and join with each other.

As a result of making the surface of the disk 235 hydrophobic, the chemical liquid layers 270, 271 and 273 and puddles 272 and 274 can be formed as shown in these FIGS. 37A, 37B, 38A and 38B, and the chemical liquid processing can be proceeded by leaving the wafer W in a state that the both the surfaces thereof are immersed simultaneously in the chemical liquid in this way for a specific time. Since the chemical liquid is not necessarily constantly fed during the chemical liquid processing, consumption of chemical liquids can be reduced as a result. Normally, the forms of the chemical liquid layers 270, 271 and 273 and puddles 272 and 274 are kept with a wafer W stayed still, but the wafer W can be rotated at a specific low speed as long as the forms of these chemical liquid layers 270, 271 and 273 and puddles 272 and 274 can be kept. Specifically, in a case that a chemical liquid which is likely to develop air bubbles therein is used, rotating the wafer W can prevent the air bubbles from staying on in one spot.

Also, as shown in FIG. 38A and 38B, in the case that the chemical liquid layer 273 or puddle 274 is formed so that the chemical liquid can cover up the entire wafer W, the edge surface of the wafer W can as well be chemical-liquid processed, and thus quality of the cleaning can be improved. Moreover, the chemical liquid layer 273 or puddle 274 can be firmly formed by forming the disk 235 to have a longer outside diameter than the outside diameter of a wafer W. Additionally, while cleaning a wafer W and spinning a cleaning liquid off the wafer W, the holding members 225a to 225c which hold the wafer W are spattered with the cleaning liquid. The cleaning liquid thus staying on the holding members 225a to 225c is to be spun off by a centrifugal force when the wafer W is rotated; however, the cleaning liquid can be more completely spun off by coating the surface of the holding members 225a to 225c with a fluorocarbon resin, etc. as well to have a hydrophobic property.

Next, one embodiment of a cleaning process wherein a wafer W is cleaned by forming the chemical liquid layers 270 and 271 in spaces between the cover member 280 and a wafer W and between the disk 235 and the wafer W as previously shown in FIGS. 37A and 37B is described below using the above-described cleaning system 201. In this embodiment, the wafer transfer unit (TRS) 214a is utilized to mount a wafer W which is carried from the side of the in/out port 204 to the side of the cleaning module 203, and the wafer transfer unit (TRS) 214b is utilized to mount a wafer W which is carried from the side of the cleaning module 203 to the side of the in/out port 204.

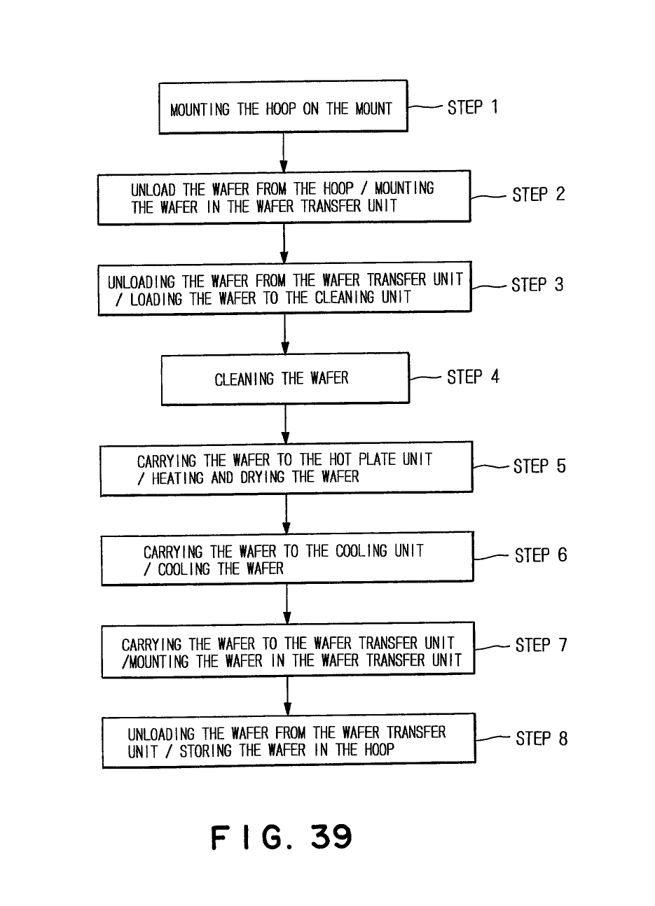

FIG. 39 is an explanatory chart of the process (flow chart) briefly showing a cleaning process which is described below. Firstly, the hoop F containing a specific number of wafers W with their front surfaces up is to be mounted on the mount 211 (Step 1). Secondly, under the condition that the window portion 292 and the cover member of the hoop F are open by the window open/close mechanism 212, the wafer carrying apparatus (CRA) 213 carries a wafer W retained in a specific slot inside the hoop F from the hoop F to the wafer transfer unit (TRS) 214b and mounts the wafer W therein (Step 2). Then, the main wafer-carrying apparatus (PRA) 215 unloads the wafer W from the wafer transfer unit (TRS) 214a and carries the same to one of the cleaning units 221a to 221d (Step 3), and the wafer W is cleaned (Step 4).

At the step 4 for the cleaning, for example, under the condition shown in FIG. 33, firstly a layer of SC-1 is to be formed in a space between the disk 235 and a wafer W by feeding SC-1 into the space between the disk 235 and the wafer W through the cleaning liquid discharge opening 241, and also a layer of SC-1 is to be formed in a space between the cover member 280 and the wafer W by feeding SC-1 into the space between the cover member 280 and the wafer W through the cleaning liquid discharge opening 281. The state shown in FIG. 37A is prepared in this fashion. SC-1 is stopped feeding when the layer of SC-1 is formed, and the wafer W is left for a specific time in a state that the both surfaces thereof make contact with SC-1, without rotating the spin chuck 223. In a chemical liquid processing in this way, consumption of SC-1 per wafer W is reduced because SC-1 is not continuously provided.

Secondly, pure water (DIW) is to be fed into spaces between the disk 235 and the wafer W and between the cover 280 and the wafer W to pour SC-1 out of each space in between and rinses both the surfaces of the wafer W. The poured out SC-1 is to be a waste fluid diluted by pure water, but in a case the waste fluid contains a high concentration of SC-1, the waste fluid has to be collected through the drain system 232 and the waste fluid pipe 264a, and after the waste fluid contains almost no SC-1, the wasted fluid is to be collected through the drain system 232 and the waste fluid pipe 264b (Refer to FIG. 35).

Next, the pure water on the surface of the wafer W is to be removed, and then, DHF is fed into spaces between the disk 235 and the wafer W and between the cover member 280 and the wafer W, and the wafer W remains with layers of DHF formed on both the surfaces thereof for a specific time. As the previous processing with SC-1, it is not necessary to continuously feed DHF into the spaces between the disk 235 and the wafer W and between the cover member 280 and the wafer W, and consumption of DHF is reduced as a result.

After completing the liquid processing with DHF for a specific time, pure water (DIW) is to be fed into spaces between the disk 235 and the wafer W and between the cover 280 and the wafer W to pour DHF out of each space in between, and the wafer W is to be completely rinsed with the pure water. While the waste fluid contains a high concentration of DHF, the waste fluid is to be collected through the drain system 232 and the waste fluid pipe 264c, and after the waste fluid contains almost no DHF, the wasted fluid is to be collected through the drain system 232 and the waste fluid pipe 264b (Refer to FIG. 35).

After the rinse processing is completed, the cover member 280 is to be retreated to the position shown in FIG. 32, and also the stage 224 is to be retreated (down) to the position shown in FIG. 34, and the wafer W remains in a state that a puddle of pure water is formed on its upper surface, and then the spin chuck 223 is to be rotated at a specific rotation speed, e.g., about 5,000 rpm, so as to spin off the pure water staying on both the surfaces of the wafer W. In this way, the cleaning of both the surfaces of the wafer W is completed.

After the cleaning is completed, the wafer W is to be carried to either of the hotplate units (HP) 216a to 216c by the main wafer-carrying apparatus (PRA) 215 to be heated and dried therein (Step 5) and then carried to the cooling unit (COL) 216d to be cooled down (Step 6). After cooling, the wafer W is to be carried from the cooling unit (COL) 216d to the wafer transfer unit (TRS) 214b by the main wafer-carrying apparatus (PRA) 215 and mounted therein (Step 7). The wafer W mounted in the wafer transfer unit (TRS) 214b is to be carried back into a specific slot inside the hoop F by the wafer carrying apparatus (CRA) 213 (Step 8). These steps are to be taken for all wafers W deposited inside the hoop F, and after completing the processing of all the wafers W, the hoop F is transferred from the mount 211 to an apparatus, etc. for the next processing.

The structure of the processing cup 222 and drain system 232, which are both constituents of the cleaning unit (CLU) 221a, can be changed. Then, another embodiment of a processing cup used for the cleaning units (CLU) 221a to 221d will be described next.

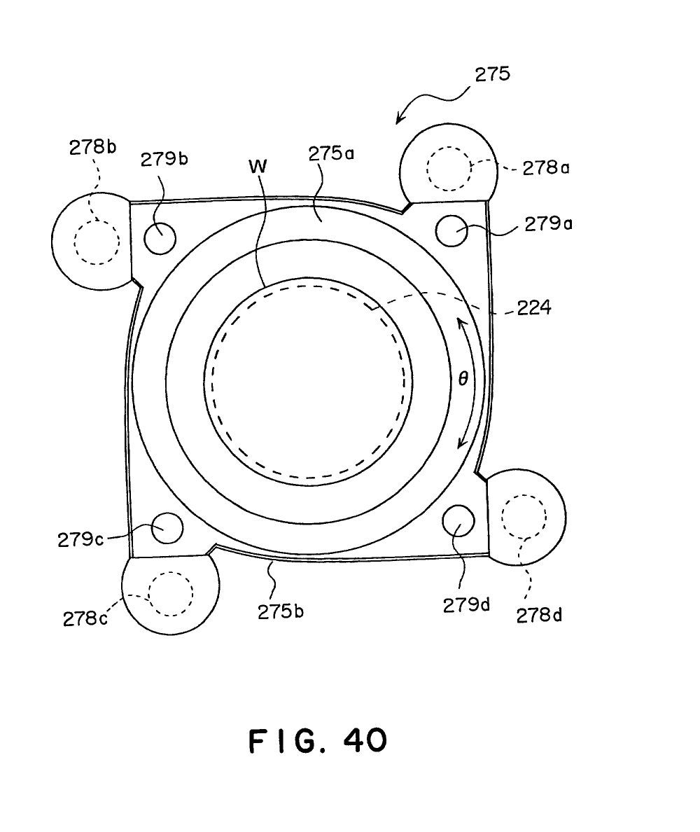

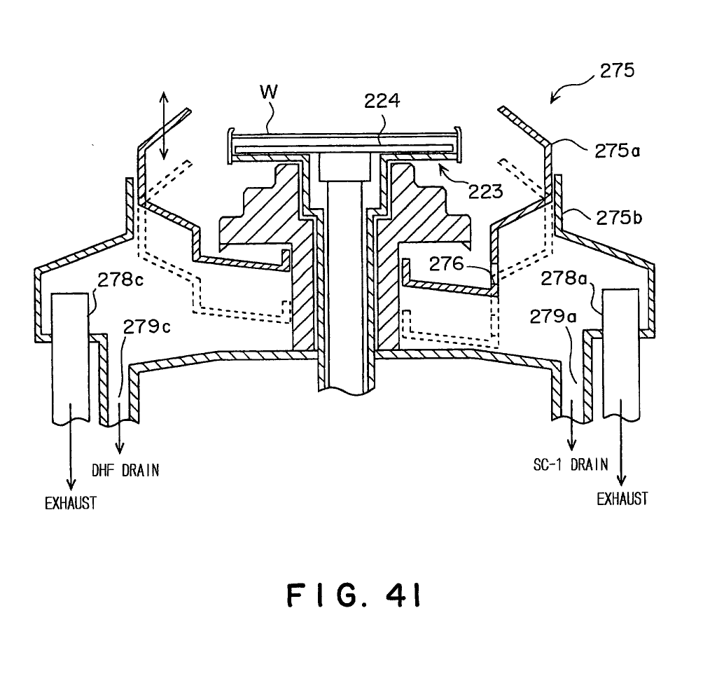

FIG. 40 is a diagrammatical plane view of a processing cup 275 including drains 279a to 279d for 4 different routes for waste fluids, and FIG. 41 is a cross-sectional view showing a diagrammatic structure of the processing cup 275 and its inside elements. Although the processing cup 275 includes the constituents, such as a spin chuck 223, stage 224, etc. as previously shown in FIG. 33 and FIG. 34, the structures thereof are simplified in FIG. 40 and FIG. 41.

The processing cup 275 comprises an inside cup 275a and a drain cup 275b surrounding the inside cup 275a. The inside cup 275a can be held at a specific angle in Θ direction by being rotated by a rotation mechanism, not shown, and also can shift upward and downward by a lift mechanism, not shown. The bottom wall of the inside cup 275a has an inclination, and a drainage 276 is formed on the lower side of the inclined bottom wall. Accordingly, a cleaning liquid fed on a wafer W is discharged through the drainage 276 to either of drains 279a to 279d.

The drain cup 275b includes the drains 279a to 279d for 4 different routes for waste fluids, and vents 289a to 278d are formed near the drains 279a to 279d respectively. For example, the drain 279a is used for discharging SC-1, the drain 279b for pure water (DIW) and drain 279c for DHF. The drain 279d is formed as a spare assuming that another chemical liquid may be used; spare drains like this can be formed at more than 2 points.

The method of using the spin chuck 223, stage 224 and cover member 280 for cleaning by the cleaning unit (CLU) including the processing cup 275 is the same as the case of cleaning by the cleaning unit (CLU) 221a. However, in the cleaning unit (CLU) 221a, a discharged processing liquid is separately collected by switching the electromagnetic valve 263a to 263c; on the other hand, in the cleaning unit (CLU) including the drain cup 275, in order to use a specific one of the drains 279a to 279d corresponding to a processing liquid discharged, the position of the drainage 276 is adjusted to the position of a specific one of the drains 279a to 279d by rotating the inside cup 275a by a specific degree corresponding to the proceedings of the liquid processing.

For example, at the beginning of the wafer W cleaning, the position of the drainage 276 is adjusted to the position of the drain 279a, and after feeding SC-1 into the spaces between the disk 235 and the wafer W and between the cover member 280 and the wafer W and the wafer is left as it is for a specific time, SC-1 is poured out from the spaces by feeding pure water (DIW) into the spaces between the disk 235 and the wafer W and between the cover member 280 and the wafer W, and then, the poured out waste fluid mainly composed of SC-1 is discharged through the drain 279a.

After SC-1 concentration of the wasted fluid discharged through the drainage 276 is lowered in this way, the position of the drainage 276 is adjusted to the position of the drain 279b by rotating the inside cup 275a by 90°, and then the wasted fluid mainly composed of pure water (DIW) is discharged through the drain 279b. Next, before starting the processing with DHF, the position of the drainage 236 is adjusted to the position of the drain 279c by rotating the inside cup 275a further by 90°, and then DHF is fed into spaces between the disk 235 and the wafer W and between the cover member 280, and the wafer W is left with layers of DHF formed thereon for a specific time.

After the specific time for the liquid processing with DHF is passed, DHF is poured out from the spaces by feeding pure water (DIW) into the spaces between the disk 235 and the wafer W and between the cover member 280, and the wafer W is completely rinsed with pure water. The poured out waste fluid is discharged through the drain 279c while DHF concentration of the poured out waste fluid is high, and after the waste fluid contains almost no DHF, the wasted fluid can be collected by rotating the inside cup 275a to adjust the position of the drainage 276 to the position of the drain 279b.

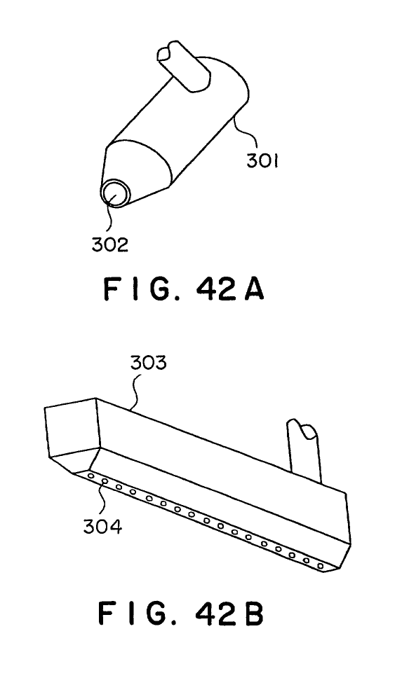

Above-stated describes the liquid processing apparatus and liquid processing method according to the present invention; however, the present invention is not limited to the above-described embodiments. For instance, when a puddle of a cleaning liquid is formed on the upper surface of a wafer W in clean-processing the wafer W, instead of using the cover member 280, cleaning of the upper surface can be achieved by forming a puddle on the upper surface of the wafer W as shown in FIG. 37B using a tubular spot nozzle 301 including one cleaning liquid discharge opening 302, a line nozzle 303 including a plurality of cleaning liquid discharge opening 304 on one side thereof or the likes, as shown in the perspective views in FIG. 42A and FIG. 42B. In this case, however, the temperature of the formed puddle is difficult to control although the temperature of the cleaning liquid provided for a wafer W can be easily controlled. Also, both of the cover member 280 and the line nozzle 303 can be disposed in the cleaning units (CLU) 221a to 221d which is structured for either of the cover member 280 or the line nozzle 303 to be chosen corresponding to the desired cleaning accuracy. Additionally, in the rinsing processing, a wafer W can be rotated at a specific rotation speed.

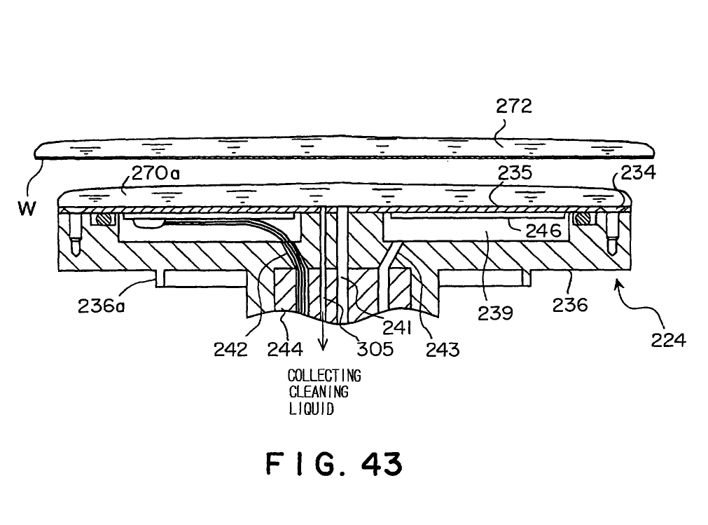

In a case that a puddle 280a of pure water (DIW), etc. is formed on the disk 235 as shown in FIG. 43 when the whole stage 224 is lifted up for a specific distance after a liquid processing of a wafer W is completed, the cleaning liquid on the disk 235 can be collected, in the same way as feeding a cleaning liquid on the surface of the disk 235 by disposing a cleaning liquid discharge opening 241 and the cleaning liquid feed pipes 245a to 245c for example, by disposing a cleaning liquid collecting opening 305, a cleaning liquid collecting pipe, not shown, connected to the cleaning liquid collecting opening 305 and a suction pump, not shown, connected to the cleaning liquid collecting pipe at a substantial center of the stage 224 where the screws 234 are not mounted. In this case, it is preferable as well that the structure enables a destination of the collected processing liquid such as a collecting tank to be altered corresponding to the kinds of processing liquids to be collected. According to the above-described embodiments, a semiconductor wafer is exemplified as a substrate, but the substrate is not limited to semiconductor wafers; LCD substrates, ceramics substrates and other substrates can be substituted.

As described above, in reference to the liquid processing apparatus and the liquid processing method according to the present invention, a puddle of a processing liquid can be firmly formed since a stage disposed below a substrate supported with holding members has on its surface a hydrophobic property. Also, a puddle of a processing liquid which is high in height can be formed. As a result, an exceptional effect is obtained as the following: the distance between a substrate and the stage is less limited and a layer of a specific thickness is formed without fail so that the undersurface of a substrate can be evenly liquid-processed, and thus a substrate with high quality can be maintained. Furthermore, a processing liquid can cover up the entire wafer W including its edge, and in this case even the edge surface which is hard to be liquid-processed can be liquid-processed, and thus quality of a substrate can be improved.

Moreover, another effect is that a processing cost can be reduced; consumption of processing liquids is reduced since the processing liquids are not necessary to be fed continuously due to the fact that an ample puddle or layer of a processing liquid is formed and held keeping sufficient amount of the processing liquid. In addition, by widening the distance between a substrate and the stage, a collision of a carrying arm which transfers a substrate to and from a stage with a stage can be prevented. In this way, a working safety can be improved, and a trouble frequency can be reduced.

Furthermore, in a case that a liquid processing is made by feeding a processing liquid to a space between a substrate and a cover member wherein the undersurface of the cover member disposed above the substrate is hydrophobic to the processing liquid, the cover member can stay clean due to the fact that particles, etc. are prevented from staying on the undersurface of a cover member since the processing liquid is not likely to stay on the undersurface of the cover member after the liquid processing. Also, holding member which holds a substrate by its edge can be hydrophobic to processing liquids to prevent a processing liquid from remaining at spots where the substrate and the holding member makes contact and a liquid from staining the substrate.

What is claimed is

1. A substrate processing apparatus for processing a substrate with a processing liquid fed to the substrate, comprising:
a holding member for holding the substrate; and
a lower side member which is movable relatively with respect to an undersurface of the substrate held by the holding member between a processing position near the undersurface of the substrate and a retreat position remote from the undersurface of the substrate,
the processing liquid being fed to a space between an upper surface of the lower side member moved to the processing position and the undersurface of the substrate held by the holding member to process the undersurface of the substrate.

2. The substrate processing apparatus according to claim 1, wherein the holding member is rotatable.

3. The substrate processing apparatus according to claim 1, wherein the lower side member is movable to a processing liquid scattering position, in addition to the processing position and the retreat position, where a step of rotating the substrate to scatter away the processing liquid is performed.

4. The substrate processing apparatus according to claim 1, wherein the lower side member includes a lower side temperature adjusting mechanism for adjusting a temperature o f the processing liquid.

5. The substrate processing apparatus according to claim 4, wherein the lower side temperature adjusting mechanism includes a temperature adjusting path which is provided inside the lower side member and through which a fluid having a temperature adjusted flows.

6. The substrate processing apparatus according to claim 1, wherein the processing liquid is fed also to an upper surface of the substrate held by the holding member, and the upper surface of the substrate is processed.

7. The substrate processing apparatus according to claim 1, further comprising an upper side member which can be moved relatively with respect to an upper surface of the substrate held by the holding member to be near the upper surface of the substrate.

8. The substrate processing apparatus according to claim 7, further comprising a liquid temperature adjusting mechanism for adjusting a temperature of the processing liquid to be fed to the upper surface of the substrate.

9. The substrate processing apparatus according to claim 7, wherein the upper side member includes an upper side temperature adjusting mechanism for adjusting the processing liquid to be fed to the upper surface of the substrate.

10. A substrate processing apparatus for processing a substrate with a processing liquid fed to the substrate, comprising:
a holding member for holding the substrate in a substantially horizontal position;
a lower side member disposed in a substantially horizontal position below the substrate held by the holding member, an upper surface of the lower side member coming into contact with the processing liquid at a contact angle of not less than 50°; and
a first processing liquid feed path for feeding the processing liquid into a space between an undersurface of the substrate held by the holding member and the upper surface of the lower side member,
a layer of the processing liquid being formed in the space between the undersurface of the substrate held by the holding member and the upper surface of the lower side member.

11. A substrate processing apparatus according to claim 10, wherein said lower side member is treated to have a hydrophobic property.

12. A substrate processing apparatus according to claim 10, further comprising:
a lift mechanism for moving the lower side member upward and downward so that a distance between the undersurface of the substrate held by the holding member and the upper surface of the lower side member can be altered.

13. A substrate processing apparatus according to claim 10, wherein a surface of the holding member, which comes into contact with the substrate, has a wettability such that, when in contact with the processing liquid, a contact angle of not less than 50°.

14. A substrate processing apparatus according to claim 10, further comprising:
a rotating mechanism for rotating the holding member; and
a second processing liquid feed path for feeding the processing liquid to an upper surface of the substrate held by the holding member,
a puddle of the processing liquid being formed on the upper surface of the substrate, and the substrate is processed with the processing liquid.

15. A substrate processing apparatus according to claim 14, wherein the distance between the undersurface of the substrate and the upper surface of the lower side member is adjusted so that the layer of the processing liquid and the puddle of the processing liquid are jointed together to cover up the entire surface including an edge surface of the substrate with the processing liquid.

16. A substrate processing apparatus according to claim 10, further comprising:
a rotation mechanism for rotating the holding member;
an upper side member with an undersurface having wettability such that, when in contact with the processing liquid, a contact angle of not less than 50° being disposed so that the undersurface of the upper side member is opposite to the upper surface of the substrate held by the holing member; and
a second processing liquid feed path for feeding the processing liquid into a space between the upper surface of the substrate held by the holding member and the undersurface of the upper side member,
a layer of the processing liquid being also formed in the space between the upper surface of the substrate held by the holding member and the undersurface of the upper side member, and the substrate is processed with the processing liquid.

17. A substrate processing apparatus according to claim 14, wherein a distance between the upper surface of the substrate and the undersurface of the upper side member and a distance between the undersurface of the substrate and the upper surface of the lower side member are adjusted so that layers of the processing liquid formed on both the surfaces of the substrate are jointed together to cover up the entire surface including an edge surface of the substrate with the processing liquid.

18. A substrate processing apparatus according to claim 16, wherein the first processing liquid feed path comprises a first processing liquid discharge opening formed by piercing through the lower side member in thickness-wise direction at the substantial center of the lower side member; and a first processing liquid feed pipe disposed in communication with the first processing liquid discharge opening,
the second processing liquid feed path comprises a second processing liquid discharge opening formed by piercing through the upper side member in thickness-wise direction at the substantial center of the upper member; and a second processing liquid feed pipe disposed in communication with the second processing liquid discharge opening,
the processing liquid is fed to the space between the undersurface of the substrate held by the holding member and the upper surface of the lower side member through the first processing liquid discharge opening, and the processing liquid is fed onto the upper surface of the substrate held by the holding member through the second processing liquid discharge opening.

19. A substrate processing apparatus according to claim 16, wherein the upper side member is treated to have a hydrophobic property at least on its undersurface.

20. A substrate processing method for processing a substrate held by a holding member with a processing liquid fed to the substrate, comprising:
a first step of holding the substrate by the holding member;
a second step of moving the lower side member relatively with respect to the undersurface of the substrate held by the holding member from a retreat position which is remote from an undersurface of the substrate to a processing position which is near the undersurface of the substrate, and making the processing liquid contiguous to the undersurface of the substrate held by the holding member to process the undersurface of the substrate;
a third step of drying the substrate;
a fourth step of unloading the substrate from the holding member.

21. The substrate processing method according to claim 20, wherein in making the processing liquid contiguous to the undersurface of the substrate and processing the undersurface of the substrate, the processing liquid is puddled between the lower side member moved to the processing position and the undersurface of the substrate held by the holding member.

22. The substrate processing method according to claim 20, wherein in making the processing liquid contiguous to the undersurface of the substrate and processing the undersurface of the substrate, the substrate is rotated relatively to the lower side member.

23. The substrate processing method according to claim 20, wherein in making the processing liquid contiguous to the undersurface of the substrate and processing the undersurface of the substrate, the processing liquid is adjusted in temperature.

24. The substrate processing method according to claim 20, comprising a step of feeding the processing liquid to the an upper surface of the substrate and processing the upper surface of the substrate.

25. The substrate processing method according to claim 24, wherein the processing liquid is puddled on the upper surface of the substrate.

26. The substrate processing method according to claim 24, wherein in feeding the processing liquid to the upper surface of the substrate and processing the upper surface of the substrate, an upper side member is moved relatively with respect to the upper surface of the substrate held by the holding member.

27. The substrate processing method according to claim 26, wherein the upper side member does not contact the processing liquid fed to the upper surface of the substrate.

28. A substrate processing method according to claim 20, wherein the lower side member comes into contact with the processing liquid at a contact angle of not less than 50°;
the second step is a processing step of forming a layer of processing liquid in a space between the undersurface of the substrate and the upper surface of the lower side member, and further comprising;
a fifth step of forming a puddle of the processing liquid on an upper surface of the substrate held by the holding member.

29. A substrate processing method according to claim 28, wherein the substrate, in the second step, is held still by the holding member, the processing liquid is fed to both the upper surface and the undersurface of the substrate, feed of the processing liquid is stopped when the processing liquid is contiguous to the both the upper surface and the undersurface of the substrate, and the substrate is processed.

30. A substrate processing method according to claim 28, wherein the layer of the processing liquid and the puddle of the processing liquid formed in the second step and the fifth step are jointed together to cover up the entire surface including an edge surface of the substrate with the processing liquid, and both the upper surface and the undersurface of the substrate are processed.

31. A substrate processing method according to claim 30, wherein, after forming the layer of the processing liquid and the puddle of the processing liquid, the layer of the processing liquid and the puddle of the processing liquid are jointed together by rotating the substrate so that the layer of the processing liquid and the puddle of the processing liquid are extended beyond an edge portion of the substrate.

32. A substrate processing method according to claim 28, wherein an upper side member, whose undersurface comes into contact with the processing liquid at a contact angle of not less than 50°, is moved above the substrate relatively with respect to the upper surface of the substrate held by the holding member, the layer of the processing liquid and the puddle of the processing liquid formed in the second step and the fifth step are jointed together to cover up the entire surface including an edge surface of the substrate with the processing liquid, and both the upper surface and the undersurface of the substrate are processed.

33. A substrate processing method according to claim 28, further comprises a step of;
feeding the processing liquid to the upper surface of the substrate while an upper side member, whose undersurface comes into contact with the processing liquid at a contact angle of not less than 50°, is moved above the substrate relatively with respect to the upper surface of the substrate held by the holding member, wherein
a space between the upper surface of the substrate held by the holding member and the undersurface of the upper side member is adjusted so that the puddle of the processing liquid formed in the fifth step become a layer of the processing liquid between the upper surface of the substrate and the undersurface of the upper side member.

34. A substrate processing method according to claim 33, wherein the layer of the processing liquid and the puddle of the processing liquid formed in the second step and the fifth step respectively are jointed together to cover up the entire surface including an edge surface of the substrate with the processing liquid, and both the upper surface and the undersurface of the substrate are processed.
